(19) United States
(12) Patent Application Publication
(10) Pub. No.: US 2025/0369629 A1
(43) Pub. Date: Dec. 4, 2025

(54) COOKING APPLIANCE

(71) Applicant: LG Electronics Inc., Seoul (KR)

(72) Inventors: Dong Hun KIM, Seoul (KR); Young Jin KIM, Seoul (KR); Jeongkil KIM, Seoul (KR); Junhwan JANG, Seoul (KR); Geon KWON, Seoul (KR); Hansu LEE, Seoul (KR)

(73) Assignee: LG Electronics Inc., Seoul (KR)

(21) Appl. No.: 19/211,917

(22) Filed: May 19, 2025

(30) Foreign Application Priority Data
May 30, 2024 (KR) 10-2024-0070766
May 30, 2024 (KR) 10-2024-0070856
Dec. 16, 2024 (KR) 10-2024-0187149
Dec. 16, 2024 (KR) 10-2024-0187291

(51) Int. Cl. F24C 15/20; F24C 7/02

(52) U.S. Cl. CPC F24C 15/2064; F24C 7/02; F24C 15/2042

(57) ABSTRACT

A cooking appliance including a main body with a cavity defined therein, and a door that opens and closes the cavity. The main body includes a lighting unit that is installed in a bottom panel and irradiates light in a downward direction of the cooking appliance. The lighting unit irradiates light toward a heating cooking apparatus located below, thereby providing convenience to a user. The lighting unit includes a light source board where a plurality of light sources are aligned to be spaced apart from each other, and a diffusion plate that is disposed under the light source board and diffuses light irradiated from the light sources.

### CROSS-REFERENCE TO RELATED APPLICATION

This application claims priority to and benefit of Korean Patent Application No. 10-2024-0070766, filed on May 30, 2024, Korean Patent Application No. 10-2024-0070856, filed on May 30, 2024, Korean Patent Application No. 10-2024-0187149, filed on Dec. 16, 2024, and Korean Patent Application No. 10-2024-0187291, filed on Dec. 16, 2024, all of which are hereby expressly incorporated by reference as if fully set forth herein.

### BACKGROUND

### Field

The present disclosure relates to a cooking appliance, and more particularly, to a cooking appliance installed above a heating cooking apparatus.

### Description of Related Art

Content described in this section merely provides background information on the present disclosure and does not constitute the prior art.

A cooking appliance is a home appliance that cooks food using a microwave, which is a type of an electromagnetic wave, and/or heater heat. The cooking appliance may be generally composed of a cavity, which is a space in which the food is placed and cooked, and a door that opens and closes the cavity.

When the cooking appliance is installed indoors, it is necessary to consider efficient use of the cooking appliance, saving of an installation space, and the like.

For this reason, the cooking appliance may be disposed at a location adjacent to a heating cooking appliance, for example, a heating oven, a gas stove, and the like. Specifically, the cooking appliance may be disposed above the heating cooking apparatus.

When the cooking appliance is disposed above the heating cooking apparatus, a user may conveniently cook the food by reducing a movement in an environment in which the cooking appliance and the heating cooking apparatus are adjacent to each other. In addition, heat, oil vapor, and the like generated from the heating cooking apparatus may be discharged to the outside using the cooking apparatus as a hood.

For example, a display may be mounted on a front surface of the door equipped in the cooking appliance to provide various information to the user. The user may identify a cooked state of the food via the display.

In addition, when the display is connected to another home appliance to serve as a hub of the home appliance, information other than the cooking of the food may be obtained via the display. In addition, a command necessary for the cooking and various other commands may be input to the display by a touch method.

The cooking appliance may provide a lighting for the heating cooking apparatus disposed under. As the lighting is disposed, the cooking appliance may provide various user conveniences related to the lighting.

### SUMMARY

A purpose of the present disclosure is to provide a cooking appliance equipped with a lighting unit that may provide convenience to a user by irradiating light to a heating cooking apparatus located below the cooking appliance.

Further, a purpose of the present disclosure is to provide a cooking appliance equipped with a lighting unit that provides a highly aesthetic lighting to a user by converting a point illumination structure into a surface illumination structure.

Further, a purpose of the present disclosure is to provide a cooking appliance having a structure in which a lighting unit is stably coupled to a bottom panel constituting a main body.

Further, a purpose of the present disclosure is to provide a technology in which various software or hardware of a door coupled to a cooking appliance controls a lighting disposed in the cooking appliance based on an external situation.

Further, a purpose of the present disclosure is to provide a technology in which a control component of a door coupled to a cooking appliance performs a mood lamping function in response to various situations occurring around the cooking appliance.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

An embodiment of a cooking appliance may include a main body with a cavity defined therein, and a door that opens and closes the cavity. The main body may include a lighting member that is installed in a bottom panel and irradiates light in a downward direction of the cooking appliance. The lighting member may irradiate light toward a heating cooking apparatus located below, thereby providing convenience to a user.

The lighting member may include a light source board where a plurality of light sources are aligned to be spaced apart from each other. The lighting member may include a diffusion plate that is disposed under the light source board and diffuses light irradiated from the light sources.

Light irradiated from the light source board may be changed into surface illumination while passing through the diffusion plate.

The lighting member may include a cover glass disposed under the diffusion plate and constructed to close an interior of the lighting member. The lighting member may include a lower cover disposed under the cover glass and coupled to the bottom panel, wherein the cover glass is mounted on the lower cover.

The lighting member may include a reflector disposed on the light source board and constructed to accommodate the light source board therein. The lighting member may include the reflector that reflects light irradiated from the light source so as to be directed downward.

The lower cover may include a first catching protrusion protruding upward from an edge of the lower cover and inserted through the bottom panel and the second part of the reflector. The lower cover may include a first bendable protrusion protruding upward from the edge of the lower cover and bent to be coupled with the diffusion plate.

The bottom panel may include a first bent portion formed by bending at an edge of the lighting mounting hole. The bottom panel may include a first insertion hole defined in the first bent portion, wherein the first catching protrusion is inserted into the first insertion hole.

An end of the first catching protrusion may include a bent first catching bent portion, and the first catching bent portion may be caught on the first bent portion.

The bottom panel may include a second catching protrusion protruding upward from an edge of the lighting mounting hole and inserted through the second part, and a second bendable protrusion protruding upward from the edge of the lighting mounting hole and bent to be coupled with the second part.

The second part may include a second insertion hole defined at a location corresponding to the second catching protrusion, wherein the second catching protrusion is inserted into the second insertion hole. An end of the second catching protrusion may include a bent second catching bent portion. The second catching bent portion may be caught on the second part after passing through the second insertion hole.

Such catching protrusions and bendable protrusions may allow the lighting member to be easily assembled and at the same time to be firmly and stably coupled to the bottom panel.

Another embodiment of the cooking appliance may include a functional unit providing a cooking function; and a digital controller door instructing the operation of the functional unit and providing a human interface.

An OS (Operating System) controller controlling the digital controller door may perform a mood-light effect process using ambient illuminance detected by an illuminance sensor disposed on the digital controller door and human body detection information detected by an infrared sensor disposed on the digital controller door.

The OS controller may perform the mood-light effect process in response to that the ambient illuminance detected by the illuminance sensor is lower than a reference illuminance and the infrared sensor detects the human body.

The digital controller door may include the OS controller which is configured to determine whether to perform the mood-light effect process based on a difference between the ambient illuminance and the reference illuminance, and current time zone information.

The OS controller may perform the mood-light effect process in response to that the time duration for which the infrared sensor has detected a human body is larger than a reference detection time duration.

In response to that an input occurs to stop the mood-light effect process after performing the mood-light effect process, the OS controller may stop the mood-light effect process and store a counter value and a history occurring in response to the mood-light effect stop.

The mood-light effect process may include a process in which the OS controller operates an outside lamp disposed in the functional unit or a door lamp disposed in the digital controller door.

The mood-light effect process may include a process in which the OS controller outputs an image or a video to a display disposed on a front surface of the digital controller door.

The OS controller may end the mood-light effect process in response to that the ambient illuminance detected by the illuminance sensor is higher than the reference illuminance or when the infrared sensor does not detect a human body.

Another embodiment of the cooking appliance may include a functional unit providing a cooking function; and a digital controller door instructing the operation of the functional unit and providing a human interface.

One embodiment of a method for controlling lighting of the cooking appliance may include a step in which an OS (Operating System) controller controlling the digital controller door checks ambient illuminance detected by an illuminance sensor disposed on the digital controller door and human body detection information detected by an infrared sensor disposed on the digital controller door; and a step in which the OS controller performs a mood-light effect process based on the checking result.

The method may include a step of performing, by the OS controller, a mood-light effect process in response to that the ambient illuminance detected by the illuminance sensor is lower than a reference illuminance and the infrared sensor detects a human body.

The method may include a step of determining, by the OS controller, whether to perform the mood-light effect process based on a difference between the ambient illuminance and the reference illuminance and current time zone information.

The method may include a step of performing, by the OS controller, a mood-light effect process in response to that the time duration for which the infrared sensor has detected a human body is greater than the reference detection time duration.

The method may include a step of stopping, by the OS controller, the mood-light effect process in response to that an input instructing to stop the mood-light effect process occurs after performing the mood-light effect process, and storing, by the OS controller, a counter and a history occurring in response to the mood-light effect stop.

The mood-light effect process may include a process in which the OS controller turns on an outside lamp disposed on a functional unit or a door lamp disposed on a digital controller door.

The mood-light effect process may include a process in which the OS controller outputs an image or video to a display disposed at the front surface of the digital controller door.

The method may include a step of terminating, by the OS controller, the mood-light effect process in response to that the ambient illuminance detected by the illuminance sensor is equal to or greater than the reference illuminance or when the infrared sensor does not detect a human body.

The heating cooking apparatus is disposed under the cooking appliance according to the present disclosure, and the user needs the lighting when using the heating cooking apparatus. Therefore, the lighting unit may be disposed in the bottom panel of the cooking appliance and irradiate light toward the heating cooking apparatus located below, thereby providing the convenience to the user.

In addition, in the cooking appliance according to the present disclosure, because the diffusion plate is disposed, light irradiated from the light source board may be changed into the surface illumination while passing through the diffusion plate. Accordingly, the lighting unit may provide the visually beautiful and convenient lighting to the user.

In addition, in the cooking appliance according to the present disclosure, the lower cover may include the first catching protrusion and the first bendable protrusion, and the bottom panel may include the second catching protrusion and the second bendable protrusion. By such catching protrusions and bendable protrusions, the lighting unit may be easily assembled and at the same time firmly and stably coupled to the bottom panel. In addition, because of such a structure, the assembly of the lighting unit and the coupling of the bottom panel may be easily performed.

In addition, in the cooking appliance according to the present disclosure, the various software or hardware of the door coupled to the cooking appliance may control the lighting disposed in the cooking appliance based on the external situation to enhance user experience.

In addition, in the cooking appliance according to the present disclosure, the control component of the door coupled to the cooking appliance may perform the mood lamping function in response to the various situations occurring around the cooking appliance to provide the user convenience.

In addition to the above-described effects, specific effects of the present disclosure will be described together while describing specific matters for implementing the present disclosure.

### BRIEF DESCRIPTION OF DRA WINGS

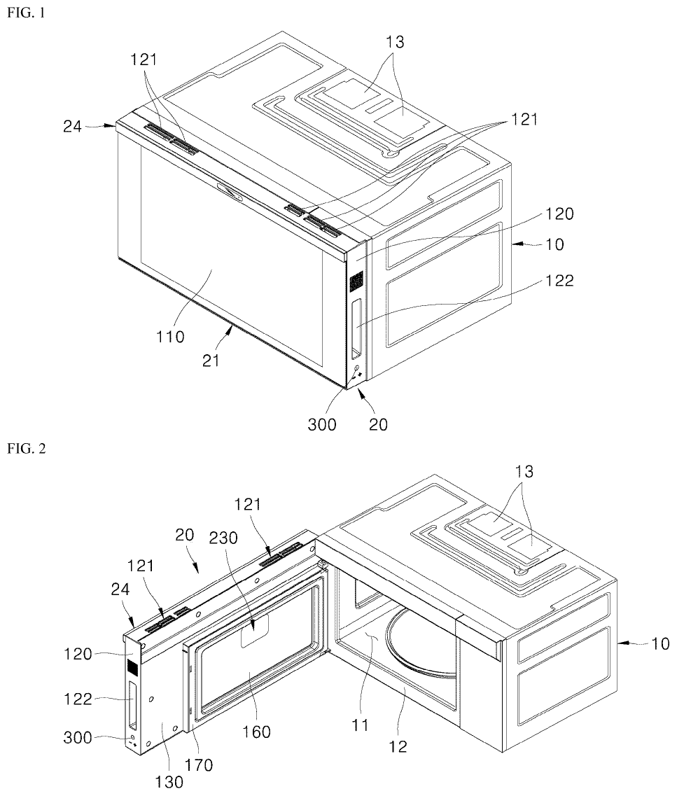

FIG. 1 is a perspective view illustrating a cooking appliance according to an embodiment.

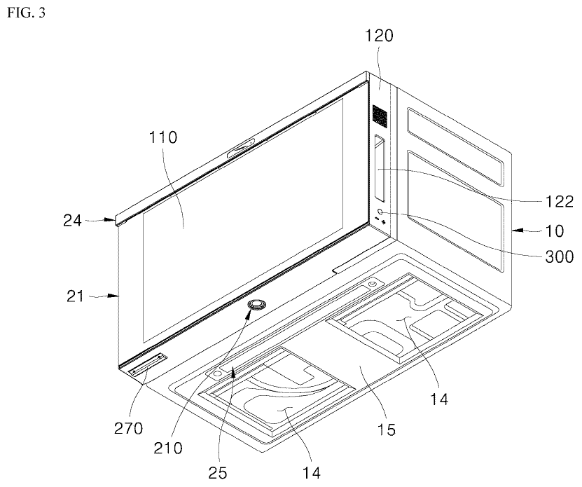

FIG. 2 is a view illustrating a state in which a door is opened in FIG. 1.

FIG. 3 is a view of FIG. 1 in another direction.

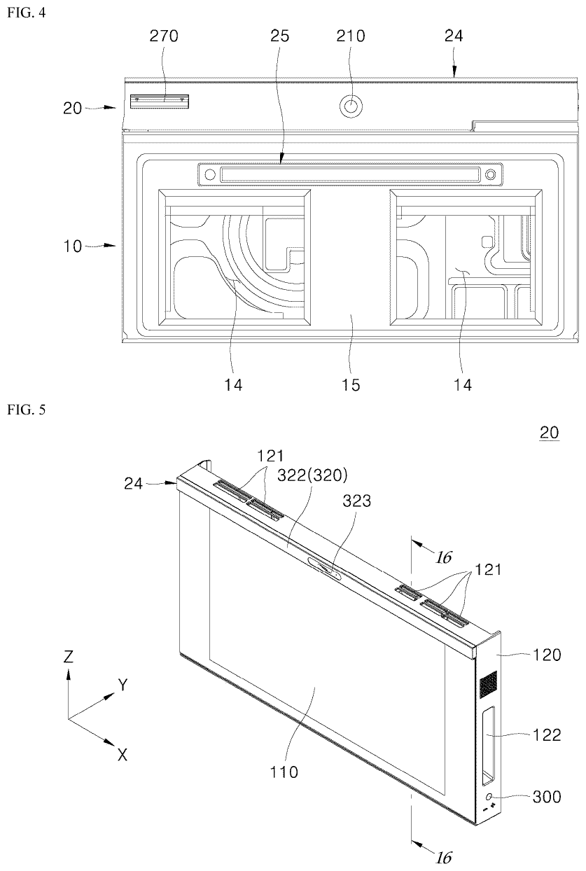

FIG. 4 is a bottom view of a cooking appliance according to an embodiment.

FIG. 5 is a perspective view illustrating a door of a cooking appliance according to an embodiment.

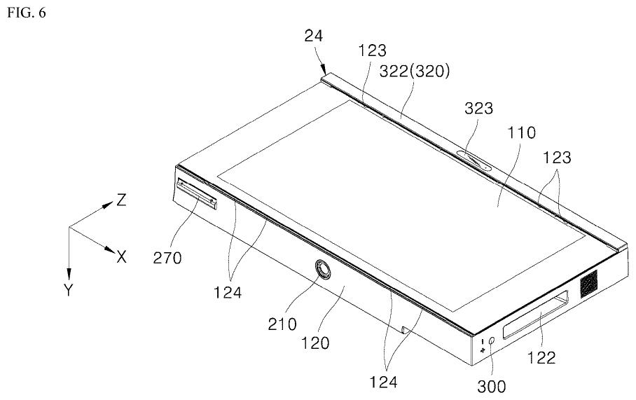

FIG. 6 is a view of FIG. 5 in another direction.

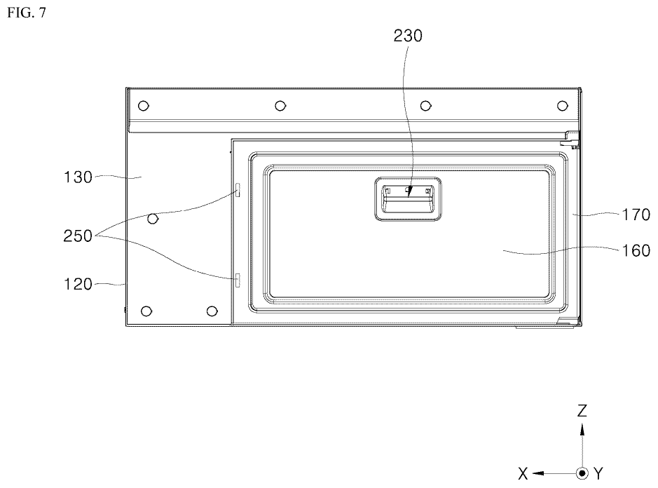

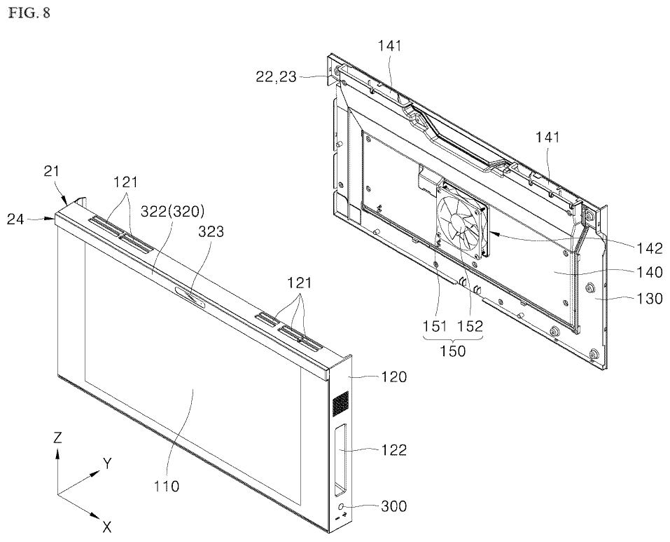

FIG. 7 is a rear view of a door.

FIG. 8 is an exploded perspective view of a portion of a door according to an embodiment.

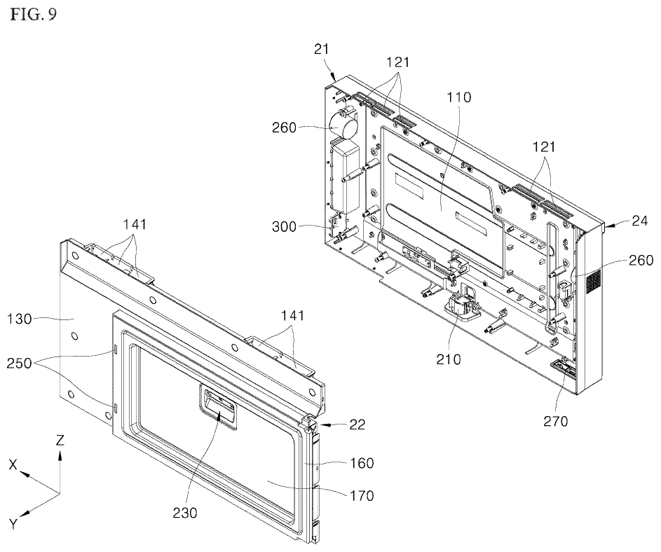

FIG. 9 is a view of FIG. 8 in another direction.

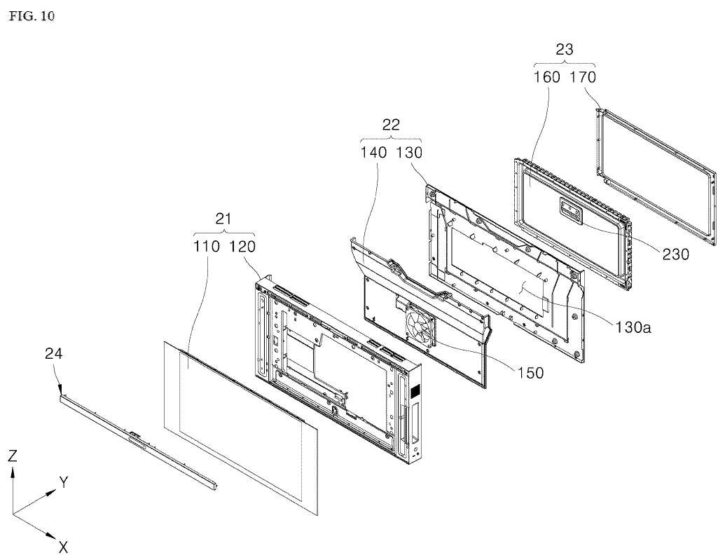

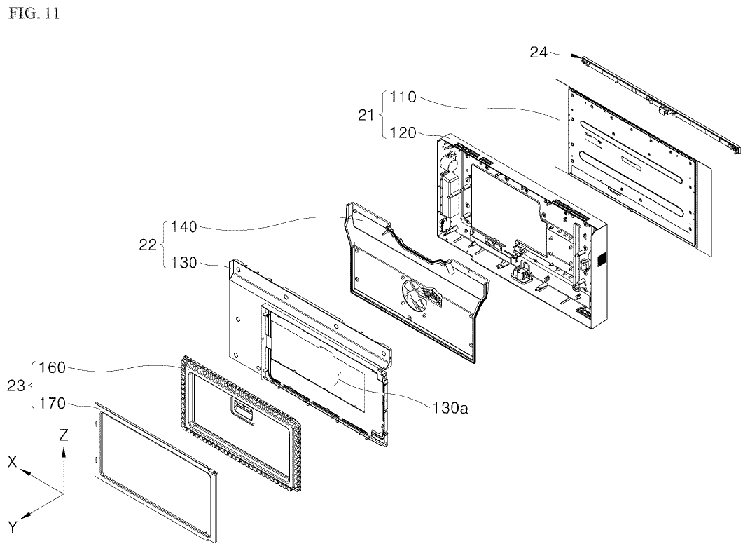

FIG. 10 is an exploded perspective view of a door according to an embodiment.

FIG. 11 is a view of FIG. 10 in another direction.

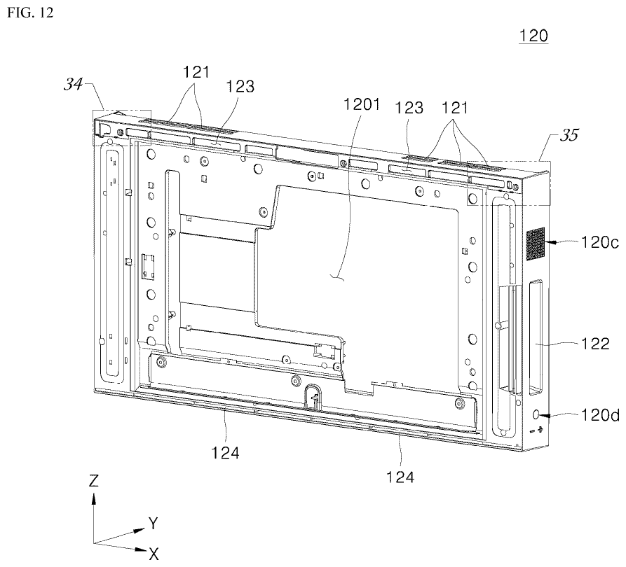

FIG. 12 is a perspective view illustrating an outer panel according to an embodiment.

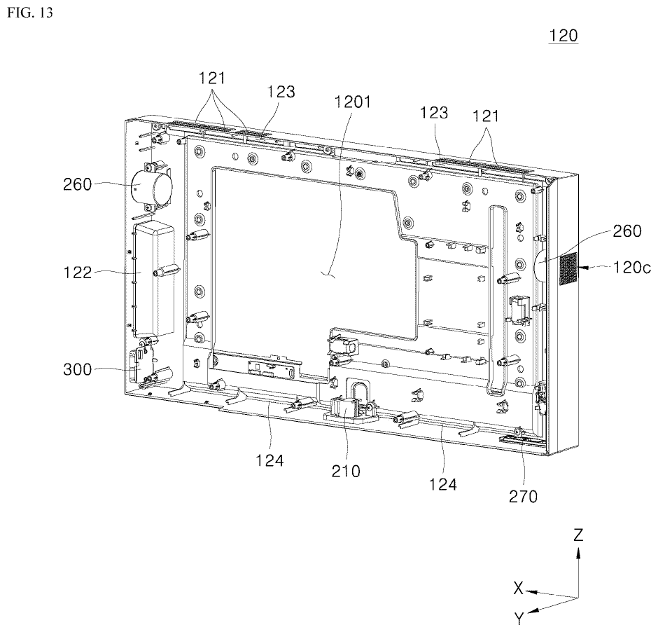

FIG. 13 is a view of FIG. 12 in another direction.

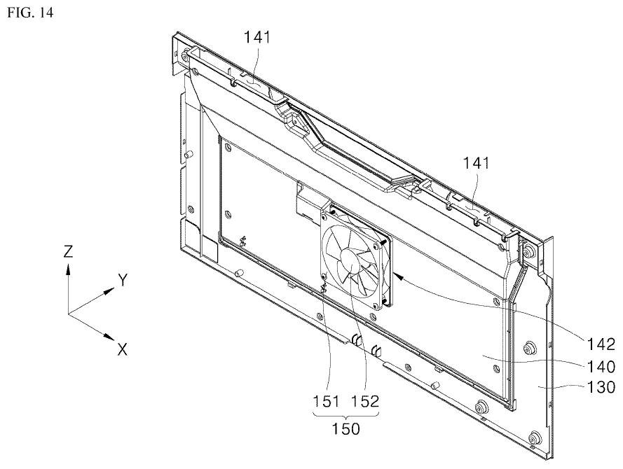

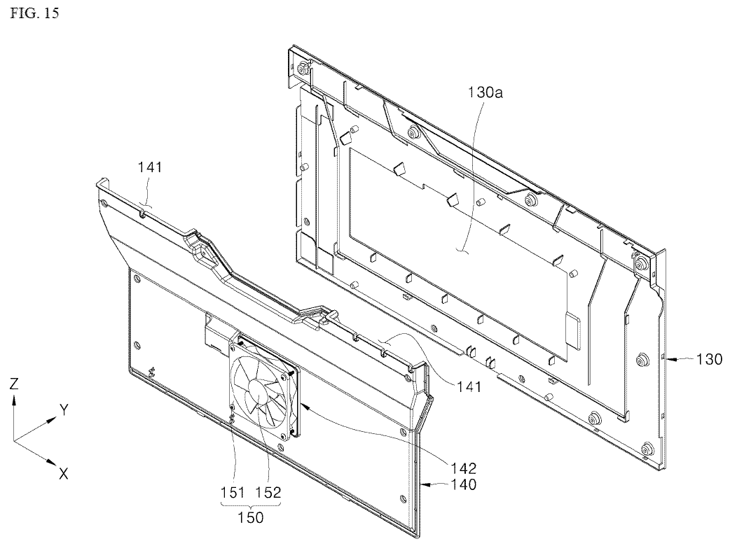

FIG. 14 is a view illustrating an inner panel and an air guide according to an embodiment.

FIG. 15 is an exploded perspective view of FIG. 14.

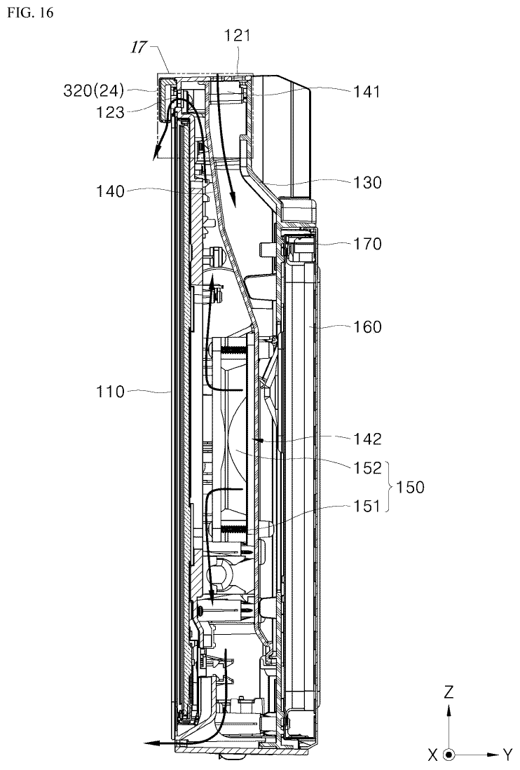

FIG. 16 is a side cross-sectional view of a door viewed in a direction 16-16 in FIG. 5.

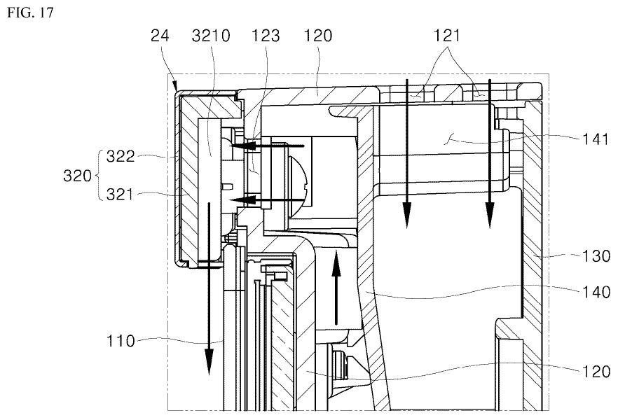

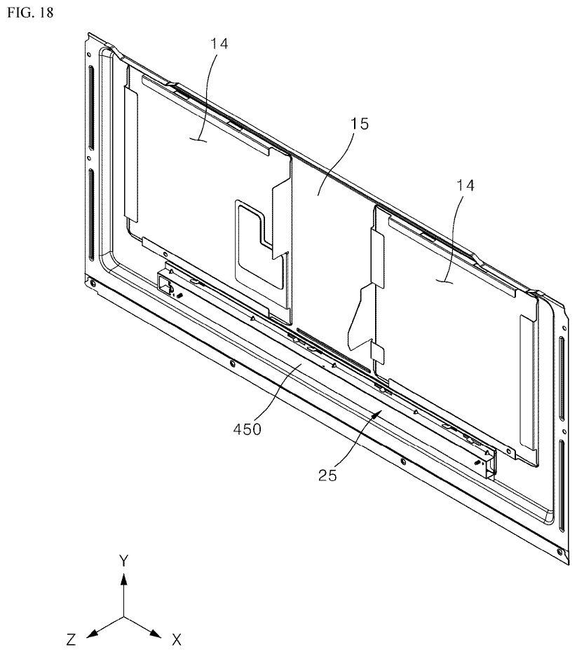

FIG. 17 is an enlarged view of a portion 17 in FIG. 16.

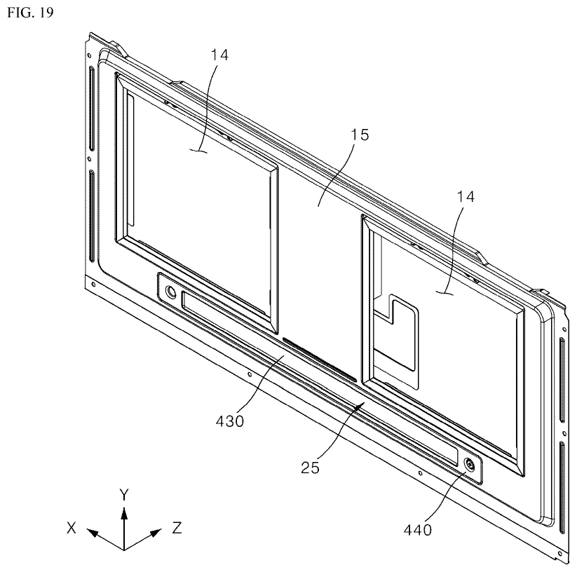

FIG. 18 is a perspective view illustrating a bottom panel and a lighting unit according to an embodiment.

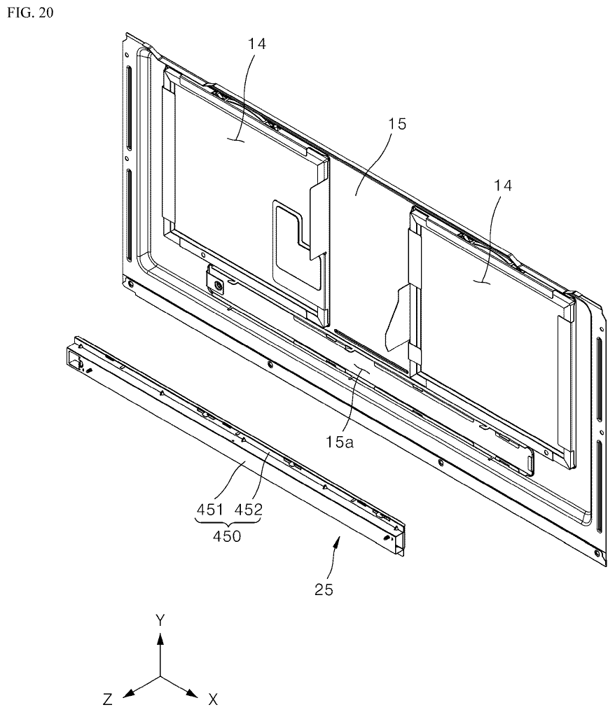

FIG. 19 is a view of FIG. 18 in another direction.

FIG. 20 is an exploded perspective view of a bottom panel and a lighting unit.

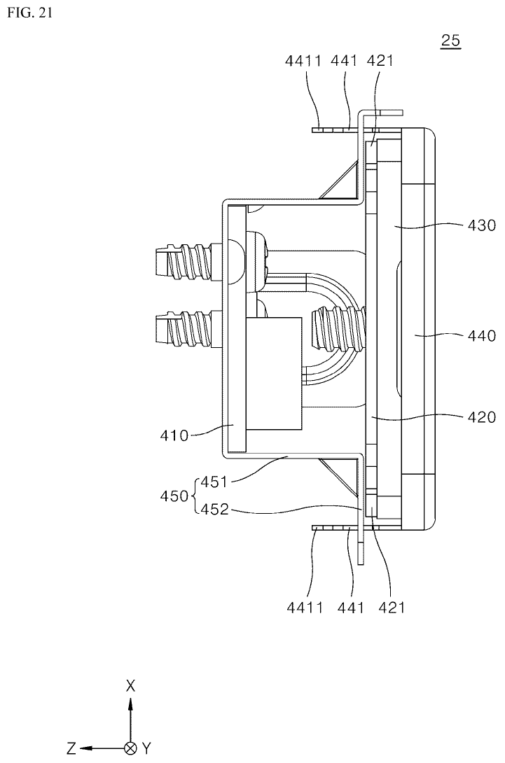

FIG. 21 is a side view illustrating a lighting unit according to an embodiment.

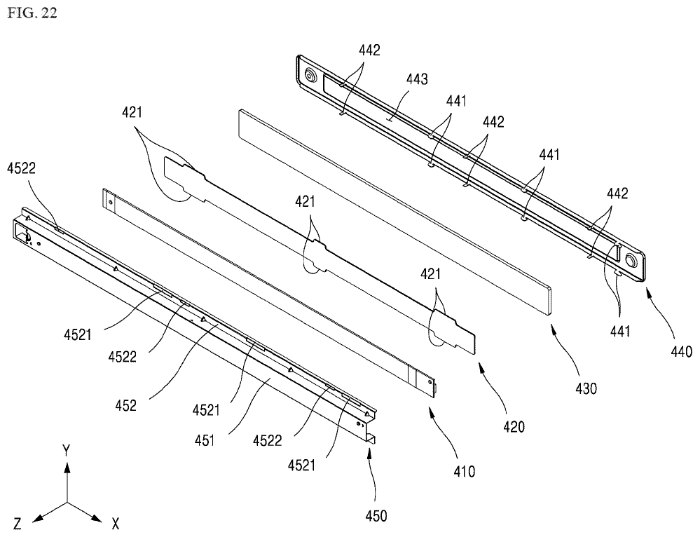

FIG. 22 is an exploded perspective view illustrating a lighting unit according to an embodiment.

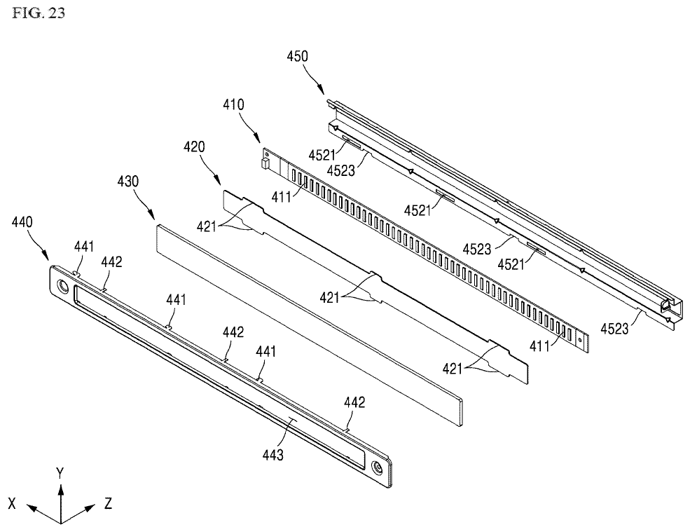

FIG. 23 is a view of FIG. 22 in another direction.

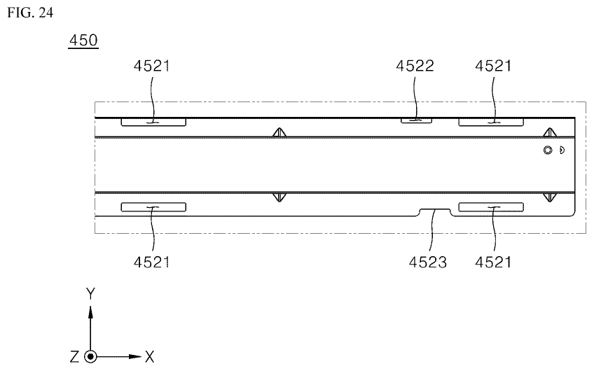

FIG. 24 is a plan view of a portion of a reflector according to an embodiment.

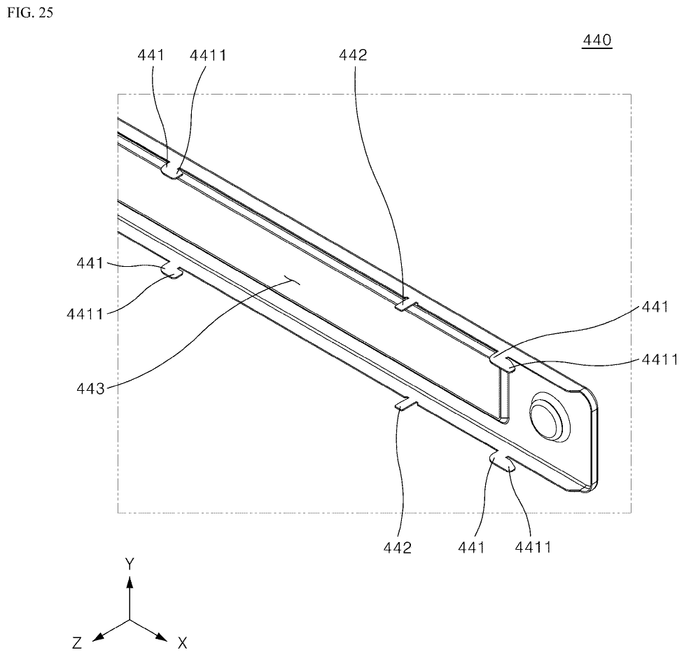

FIG. 25 is a perspective view illustrating a portion of a lower cover according to an embodiment.

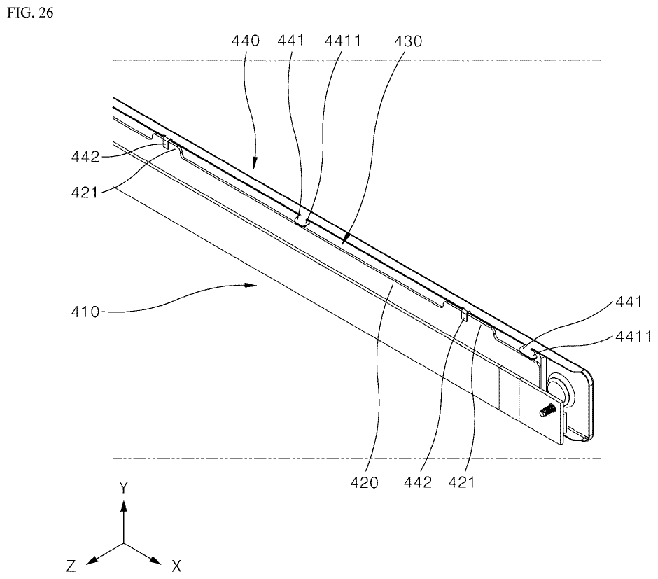

FIG. 26 is a perspective view illustrating a state in which a diffusion plate, a cover glass, and a lower cover are assembled and a light source board is disposed.

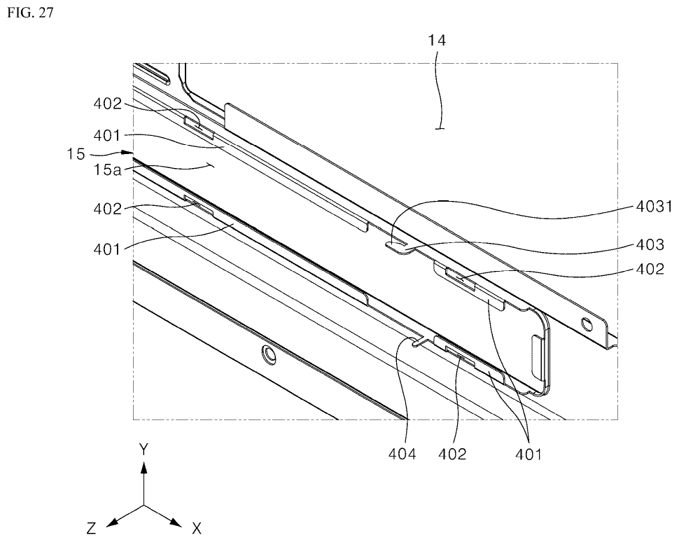

FIG. 27 is a perspective view illustrating a portion of a bottom panel.

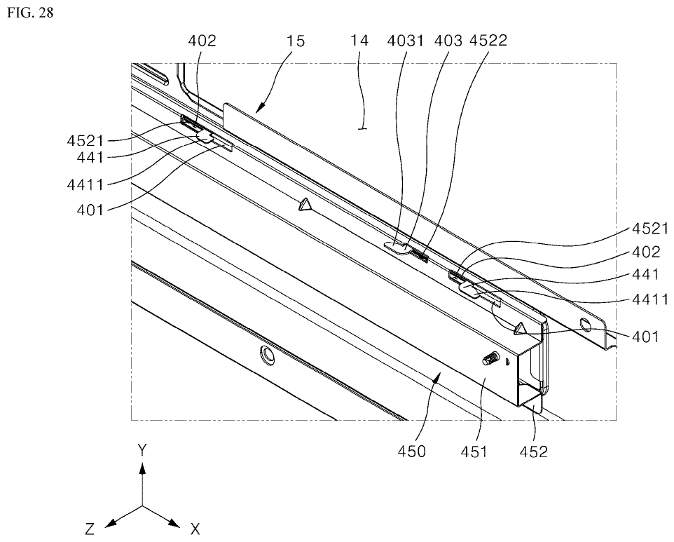

FIG. 28 is a perspective view illustrating a state in which a lighting unit is coupled to a bottom panel.

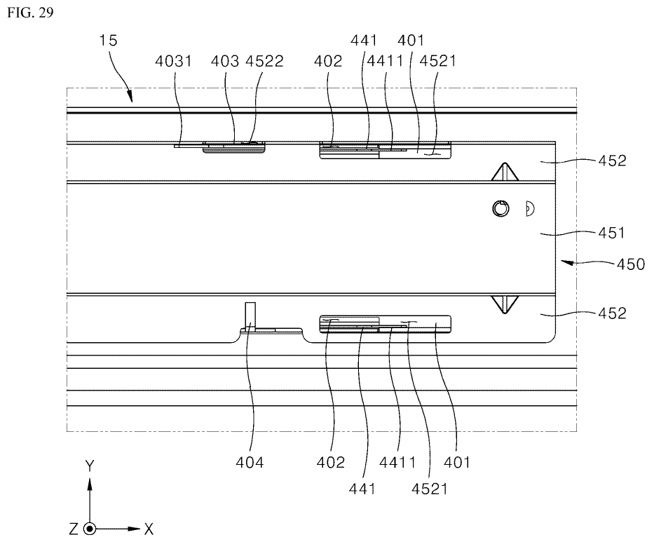

FIG. 29 is a plan view of FIG. 28.

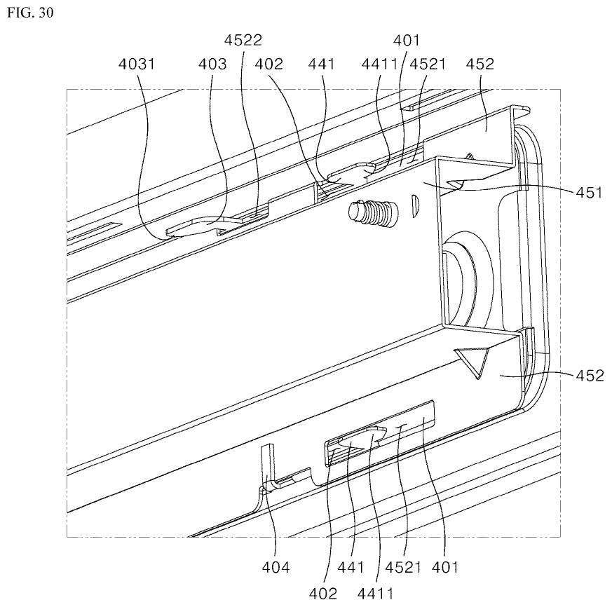

FIG. 30 is a view of FIG. 28 in another direction.

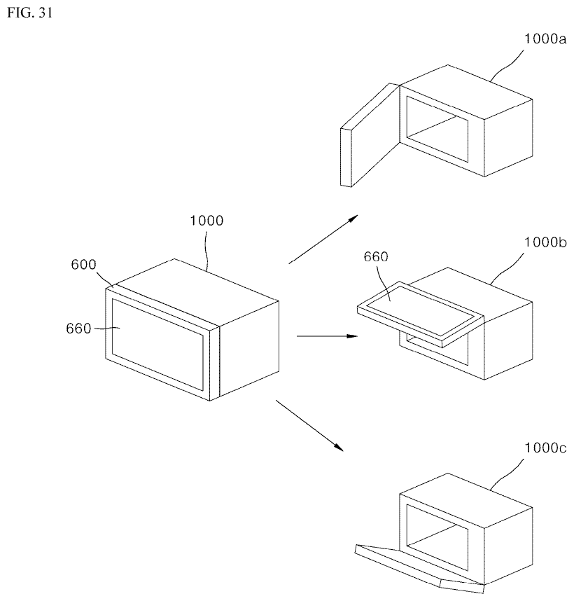

FIG. 31 is a conceptual diagram of a cooking appliance including a digital controller door according to an embodiment of the present disclosure.

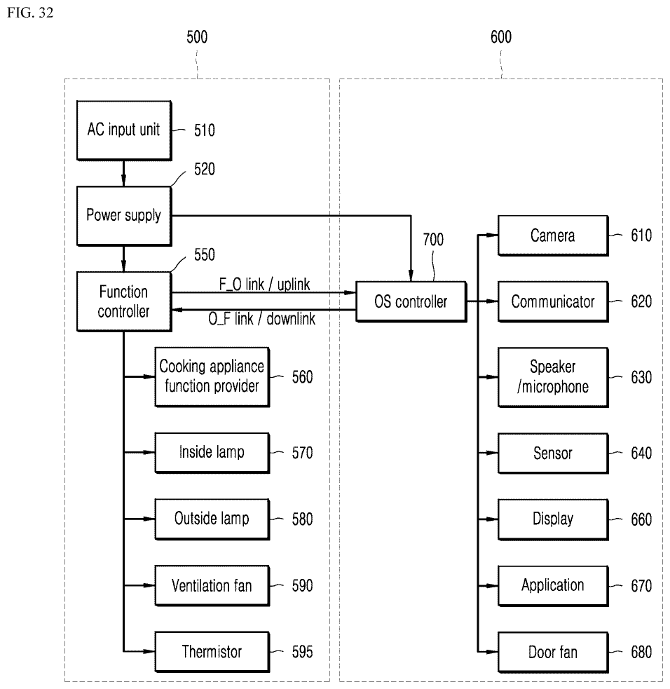

FIG. 32 is a diagram illustrating components of a digital controller door and components of a functional unit according to an embodiment of the present disclosure.

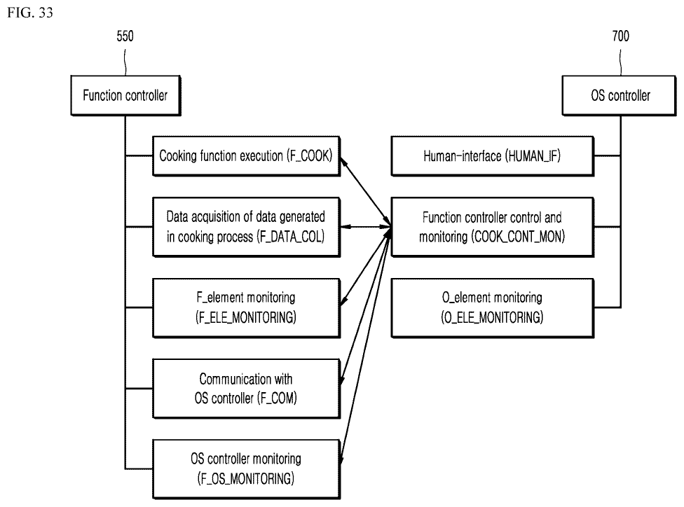

FIG. 33 is a diagram illustrating categories of functions performed by an OS controller and a function controller according to an embodiment of the present disclosure.

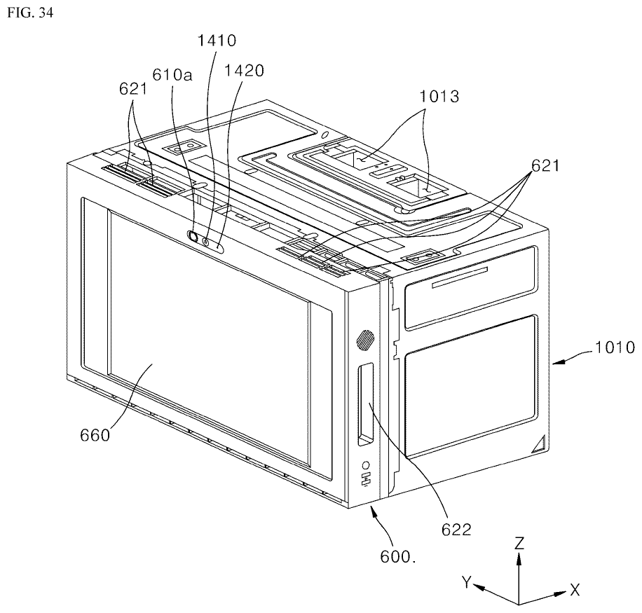

FIG. 34 is a perspective view illustrating a cooking appliance according to an embodiment of the present disclosure.

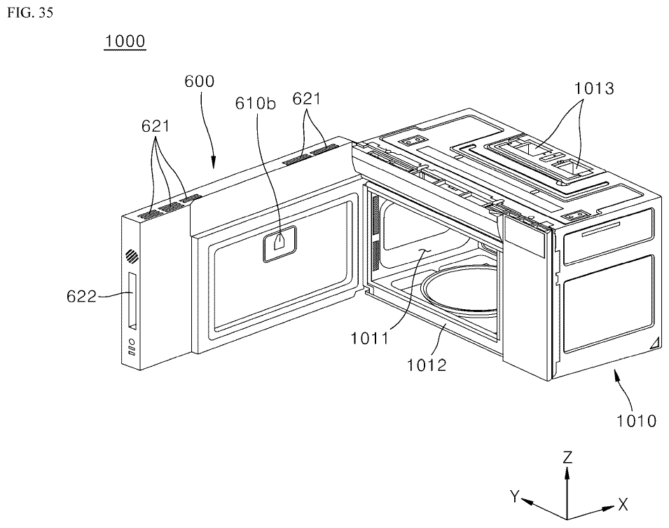

FIG. 35 is a diagram illustrating a state in which the digital controller door is opened in FIG. 34.

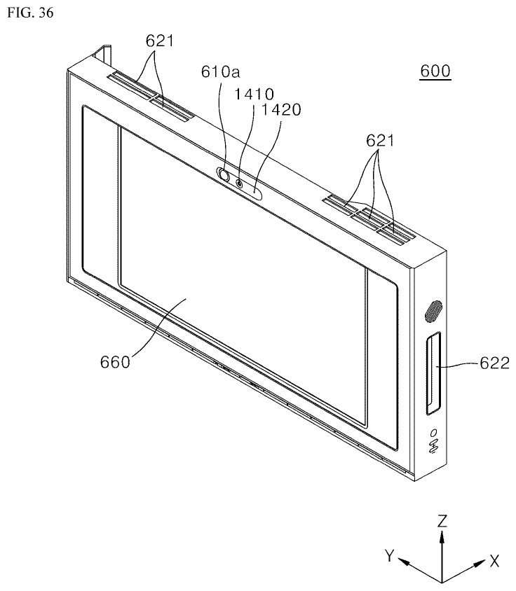

FIG. 36 is a perspective view illustrating a digital controller door of a cooking appliance according to an embodiment of the present disclosure.

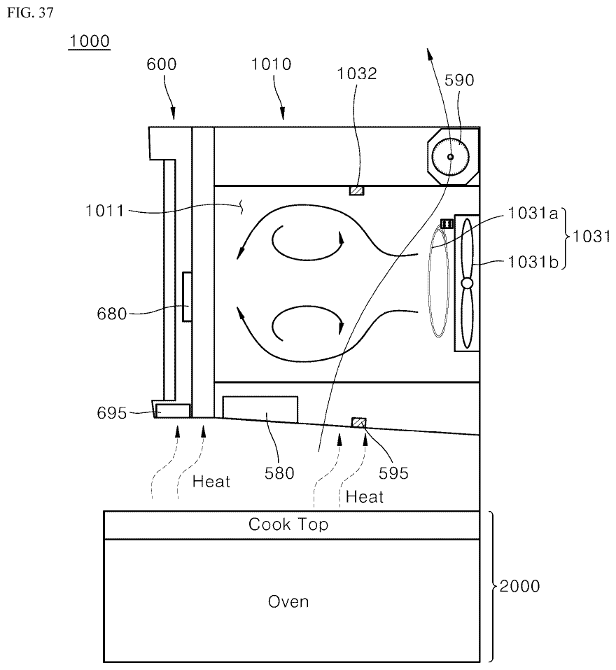

FIG. 37 is a schematic view illustrating a position where a cooking appliance is disposed according to an embodiment of the present disclosure.

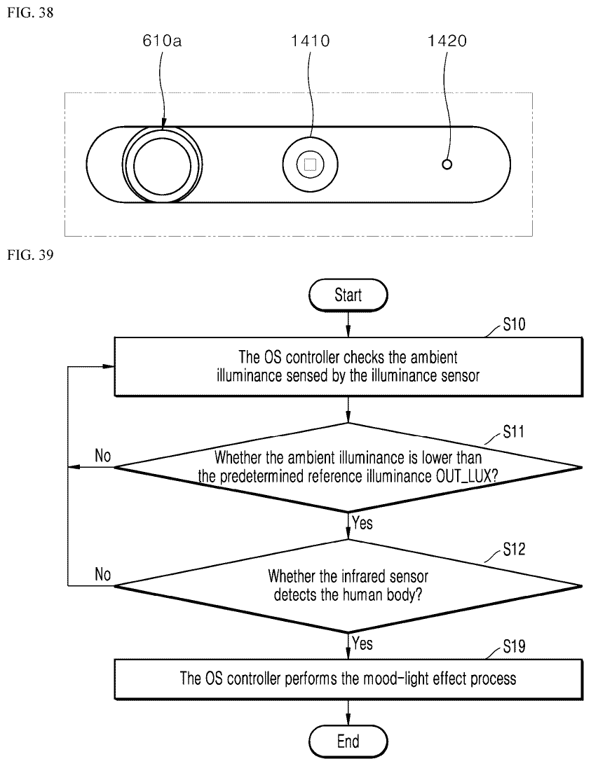

FIG. 38 is a view showing a detailed configuration of a sensor according to an embodiment of the present disclosure.

FIG. 39 is a view illustrating a process of sensing a movement of a person and providing a mood-light effect based on the sensing result, according to an embodiment of the present disclosure.

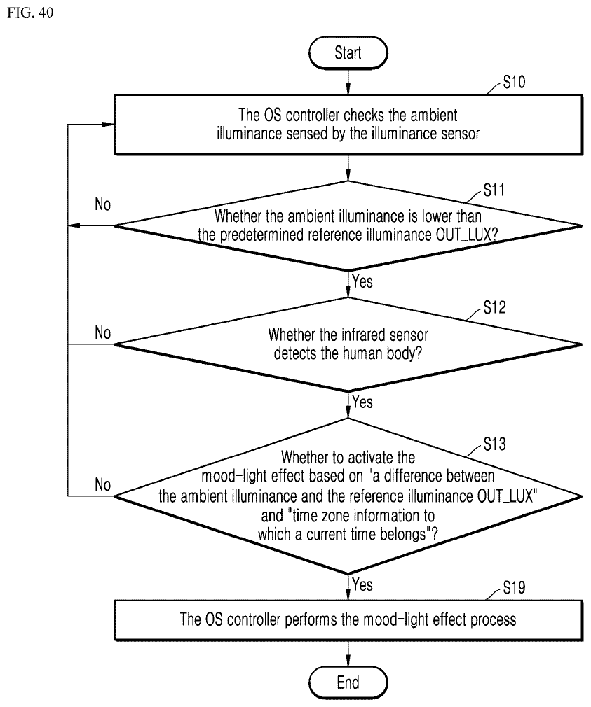

FIG. 40 is a diagram illustrating a process of providing a mood-light effect based on a time zone according to an embodiment of the present disclosure.

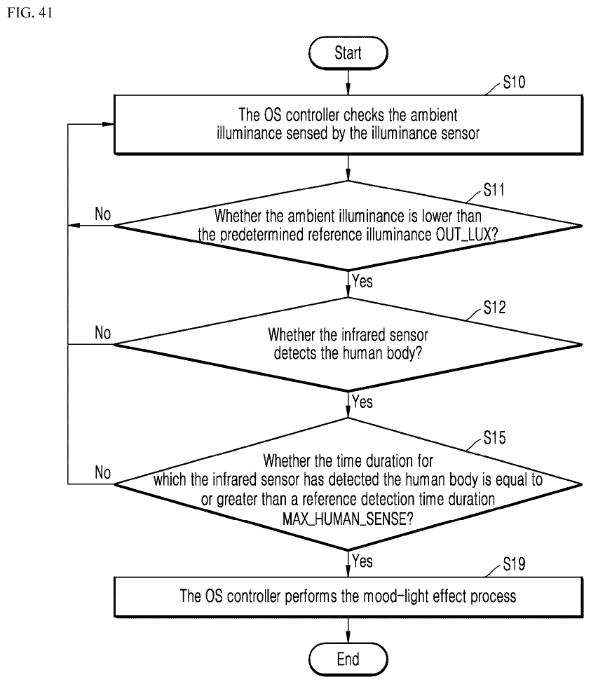

FIG. 41 is a view illustrating a process of providing a mood-light effect based on a length of a time duration for which an infrared sensor detects a person according to an embodiment of the present disclosure.

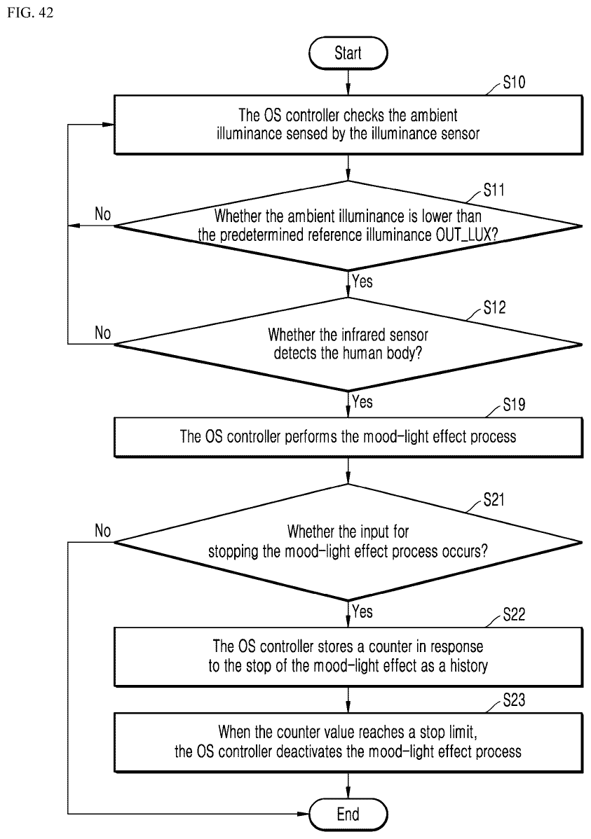

FIG. 42 is a diagram illustrating a process in the event that an input for stopping a mood-light effect process occurs after performing the mood-light effect process according to an embodiment of the present disclosure.

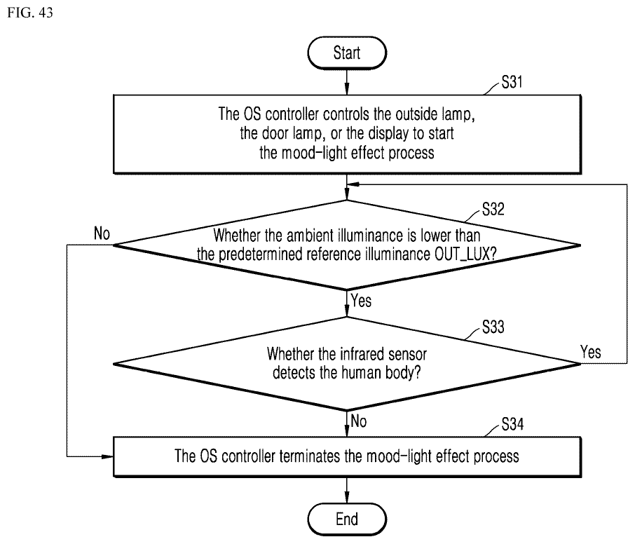

FIG. 43 is a diagram illustrating a process of terminating a mood-light effect process after performing the mood-light effect process according to an embodiment of the present disclosure.

### DETAILED DESCRIPTIONS

The above-mentioned purposes, features, and advantages will be described in detail later with reference to the attached drawings, so that those skilled in the art in the technical field to which the present disclosure belongs may easily practice the technical ideas of the present disclosure. In describing the present disclosure, when it is determined that a detailed description of the publicly known technology related to the present disclosure may unnecessarily obscure the gist of the present disclosure, the detailed description thereof will be omitted. Hereinafter, a preferred embodiment according to the present disclosure will be described in detail with reference to the attached drawings. In the drawings, identical reference numerals are used to indicate identical or similar components.

Although first, second, and the like are used to describe various components, these components are not limited by such terms. Such terms are only used to distinguish one component from another component, and unless specifically stated to the contrary, a first component may also be a second component.

Throughout the present document, unless otherwise stated, each component may be singular or plural.

As used herein, singular expressions include plural expressions, unless the context clearly dictates otherwise. In the present application, terms such as “composed of” or “include” should not be construed as necessarily including all of various components or steps described herein, and should be interpreted as being able to not including some of the components or the steps and further including additional components or steps.

Throughout the present disclosure, “A and/or B” means A, B, or A and B, unless otherwise specified, and “C to D” means C inclusive to D inclusive unless otherwise specified.

Throughout the present document, a “vertical direction” refers to a vertical direction of a cooking appliance in a state in which the cooking appliance is installed to be used on a daily basis. A “left and right direction” means a direction orthogonal to the vertical direction, and a front and rear direction means a direction orthogonal to both the vertical direction and the left and right direction. A “lateral direction” has the same meaning as the left and right direction, and such terms are able to be used interchangeably herein.

FIG. 1 is a perspective view illustrating a cooking appliance according to an embodiment. FIG. 2 is a view illustrating a state in which a door 20 is opened in FIG. 1.

The cooking appliance according to an embodiment may be disposed above a location where a heating cooking appliance, for example, a heating oven, a gas stove, and the like, is disposed, at a location spaced apart from the heating cooking appliance in the vertical direction.

Because of such an arrangement of the cooking appliance, a user may conveniently use cooking apparatuses including the cooking appliance. In addition, the cooking appliance may serve as a hood of the heating cooking apparatus disposed under. In this case, the cooking appliance may include components for the use as the hood.

The cooking appliance may cook food using a microwave, which is a type of an electromagnetic wave, and/or heater heat. The cooking appliance may include a main body 10 in which the cavity 11 is formed, and a door 20 that opens and closes the cavity 11.

The food to be cooked may be placed in the cavity 11. The door 20 may be disposed in front of the cavity 11 and pivotably mounted on the main body 10 to open and close the cavity 11.

The cooking appliance may serve as the hood for discharging gaseous foreign substances discharged from the heating cooking apparatus disposed under to the outside. To this end, a ventilation hole 13 for discharging moisture, oil vapor, and the like generated in the heating cooking appliance disposed under the cooking appliance to the outside may be defined at an upper portion of the main body 10.

The main body 10 may further include a front panel 12 that is disposed at an edge of an entrance of the cavity 11, and closes the cavity 11 by being disposed such that one surface thereof faces one surface of a choke member 170 when the door 20 is closed.

The front panel 12 may be disposed to surround the entrance edge of the cavity 11 and protrude with a predetermined width. Accordingly, when the door 20 is closed, an edge of the door 20 and the cavity 11 may overlap each other.

Because of such a structure, the front panel 12 may seal the cavity 11 in the state in which the door 20 is closed, thereby suppressing oil, moisture, oil vapor, and the like generated during a cooking process of the food placed in the cavity 11 from being leaked to the outside via the entrance of the cavity 11.

FIG. 3 is a view of FIG. 1 in another direction. FIG. 4 is a bottom view of a cooking appliance according to an embodiment.

A suction unit 14 for sucking moisture, oil vapor, and the like rising from the heating cooking appliance may be disposed at a lower portion of the main body 10. Accordingly, the cooking appliance may serve as the hood that sucks air discharged from the heating cooking appliance disposed under the cooking appliance and discharges the air to the outside.

The suction unit 14 and the ventilation hole 13 may be defined to be in communication with each other, and thus, gas such as oil vapor introduced into the suction unit 14 may be discharged to the outside via the ventilation hole 13, and the ventilation hole 13 may be in communication with a duct connected to the outside.

In one example, the cavity 11 of the cooking appliance is formed not to be in communication with the suction unit 14 and the ventilation hole 13, so that gas such as oil vapor introduced from the suction unit 14 may be discharged to the outside of the main body 10 directly via the ventilation hole 13 without being introduced into the cavity 11.

A bottom panel 15 may be disposed at the lower portion of the main body 10, and the suction unit 14 may be formed to extend through the bottom panel 15 and be in communication with the ventilation hole 13.

The bottom panel 15 may include a lighting unit 25 that irradiates light in a downward direction. Such a lighting unit may be formed, for example, in a shape long in the lateral direction of the cooking appliance. By the light irradiated from the lighting unit 25, the user may conveniently use the heating cooking appliance disposed under the cooking appliance.

FIG. 5 is a perspective view illustrating the door 20 of the cooking appliance according to an embodiment. FIG. 6 is a view of FIG. 5 in another direction.

FIG. 7 is a rear view of the door 20. FIG. 8 is an exploded perspective view of a portion of the door 20 according to an embodiment. FIG. 9 is a view of FIG. 8 in another direction.

The door 20 may include a display module 21, a cooling flow path 22, and a shielding portion 23. The display module 21 may be disposed at a front portion of the door 20, and the user may view inside of the cavity 11 of the cooking appliance through the display module 21.

The cooling flow path 22 may be disposed at the rear of the display module 21, and a flow path through which air for cooling flows may be formed therein. Air introduced into the door 20 may flow inside the door 20 via the cooling flow path 22 to cool the door 20.

The shielding portion 23 may be disposed at the rear of the cooling flow path 22, and may shield the electromagnetic wave generated in the main body 10. The shielding portion 23 may protect the user by blocking the electromagnetic wave generated in the cavity 11 and propagated to the outside of the cooking appliance.

For example, the shielding portion 23 may serve to block the electromagnetic wave (the microwave) generated to cook the food in the main body 10 from being discharged to the outside of the door 20.

The cooling flow path 22 may be disposed to cool electronic components mounted inside the door 20, including a display 110 mounted on the display module 21. In the cooling flow path, air that cools the door 20 may flow inside. The display 110 may be formed in a thin shape and may be disposed such that an area thereof occupies a significant portion of one surface of the door 20.

Accordingly, the display 110 is formed to occupy a significant portion of a front surface area of the door 20, and the area of the display 110 is increased, so that visibility to the user may be improved. The user may conveniently check the various information via the display 110 formed as a large screen.

Because the display 110 is enlarged, an amount of heat generated may increase. Therefore, the display 110 needs to be effectively cooled on the door 20. In an embodiment, the cooling flow path through which cooling air flows may be separately disposed.

The cooling flow path 22 may be disposed at the rear of the display 110, so that cooling air may flow, and thus the display module 20 may be effectively cooled by air flowing through the cooling flow path 22. In addition, heating components mounted in the display module 21 may also be cooled by air flowing through the cooling flow path 22. That is, the cooling flow path 22 may cool the display module 21 equipped with the display 110 and various other heating components.

To effectively cool the display 110, an entirety of the display 110 needs to be exposed to air flowing through the cooling flow path 22. In addition, the air flow passing through the cooling flow path 22 and discharged to the outside of the door 20 needs to form an air curtain to block heat and oil vapor rising from the heating cooking appliance disposed under the cooking appliance.

To this end, air flowing through the cooling flow path 22 may be branched from the inside of the cooling flow path 22 so as to be discharged upward and downward of the display module 21.

As cooling air is branched from the inside of the cooling flow path 22 and discharged upward and downward of the display module 21, cooling air may flow while coming into contact with an entirety of a rear surface of the display 110 to effectively cool the display 110.

In addition, as cooling air is discharged upward and downward of the display module 21, the air curtain is effectively formed around the display and the door 20, so that heat and oil vapor rising from the heating cooking appliance disposed under the cooking appliance may be effectively blocked by the air curtain.

The display module 21 may be equipped with the display 110, a camera, and other electronic components, and the cooling flow path 22 may be equipped with electronic components such as a blower 150 operated by a motor. Accordingly, to protect the user and the electronic components from the electromagnetic wave, the shielding portion 23 that shields the electromagnetic wave generated in the main body may be disposed at the rear of the cooling flow path 22.

In the display module 21, the display 110 and various electronic components may be disposed. Further, the cooling flow path 22 in which a flow path of air that cools the display module 21 is formed may be disposed at the rear of the display module 21, and the shielding portion 23 that shields the electromagnetic wave from reaching the electronic components equipped in the display module 21 may be disposed at the rear of the cooling flow path 22.

In an embodiment, the display module 21 for providing the various information and convenience to the user needs to be disposed on a front surface of the cooking appliance, that is, at a forefront of the door 20. In addition, in an embodiment, a structure is required to effectively cool the components such as the display 110 equipped in the display module 21, to form the flow path of cooling air for forming the air curtain around the door 20 while effectively cooling the inside of the door 20 equipped with the display 110 and the like, and to protect the electronic components mounted in the door 20 from the electromagnetic wave.

To meet such a need, the display module 21 may be disposed at the foremost of the door 20, the cooling flow path 22 may be disposed at the rear of the display module 21, and the shielding portion 23 may be disposed at the rear of the cooling flow path 22.

That is, to implement the door structure according to the above-described embodiment, the display module 21, the cooling flow path 22, and the shielding portion 23, which play respective roles in the door 20, need to be sequentially arranged from a front side to a rear side of the door 20.

The display module 21 may include a first outlet 123 and a second outlet 124. The first outlet 123 may be disposed at an upper portion of the display module 21, and air flowing inside the display module 21 may be discharged to the outside via the first outlet 123.

The second outlet 124 may be disposed at a lower portion of the display module 21, and air flowing inside the display module 21 may be discharged to the outside via the second outlet 124. That is, air flowing inside the door 20 may be discharged to the outside via the first outlet 123 and the second outlet 124 respectively disposed at the upper and lower portions of the door 20, and accordingly, air may flow through the entire inside of the door 20 to effectively cool the entire door 20.

The display module 21 may include the display 110 and an outer panel 120. The display 110 may be disposed on the front surface of the door 20 to display a video or an image.

The display 110 may display information necessary for the cooking and provide the information to the user. In addition, the display 110 may receive a user's command in a touch recognition method.

In one example, the display 110 may be communicatively connected to other home appliances, a camera disposed at a main door, a locking device, and the like. In addition, the display 110 may be communicatively connected to an external device required by the user.

The user may receive information necessary for operation of the home appliance, visit of an outsider, and other life from the display 110, and transmit commands to the home appliance and other devices connected to the display 110 using the display 110.

Accordingly, the door 20 including the display 110 may serve as a kind of an IoT hub that transmits the information regarding the home appliance and other devices necessary for living to the user and transmits user's commands to such devices.

The outer panel 120 may be disposed at the rear of the display 110, and the display 110 may be mounted thereon. The outer panel 120 may generally have a hollow 1201 and may be formed in a shape having a predetermined width in a front and rear direction of the door 20.

The hollow 1201 of the outer panel 120 may be closed by a rear surface of the display 110. Air flowing inside the outer panel 120 may hit the rear surface of the display 110 exposed through the hollow 1201 of the outer panel 120. Accordingly, air flowing inside the outer panel 120 may come into contact with the rear surface of the display 110 and cool the display 110.

In addition, air passing through a blower fan 152 may cool the heating components such as a speaker 260, a microphone 270, a printed circuit board, and the like, which are disposed to be exposed through the hollow 1201 of the outer panel 120.

Because the outer panel 120 has the above-described structure, it may have a built-in space, and various components may be built in the built-in space. A width of the door 20 in the front and rear direction may be determined almost by the outer panel 120.

A first ventilation hole 121 through which air is introduced may be defined in an upper end of the outer panel 120. A plurality of first ventilation holes 121 may be defined. Each of the first ventilation holes 121 may be defined such that a plurality of slit-shaped holes are arranged at a distance. Because of such a structure, the external foreign substances may be somewhat suppressed from being introduced into the door 20 via the first ventilation hole 121.

A handle 122 may be formed at one side of the outer panel 120 to be used when the user opens and closes the door 20. The handle 122 may be defined, for example, by recessing the side of the outer panel 120.

A button device 300 may be mounted on one side of the outer panel 120, for example, directly below a location where the handle 122 is formed. The user may manipulate the button device 300 to supply electricity to the cooking appliance or cut off the supply of electricity. Detailed manipulation related to the operation of the cooking appliance may be performed by inputting a command to the display 110.

The outer panel 120 may support the various components such as the display 110, the speaker 260, the microphone 270, and the printed circuit board for communication or control, and may include the first ventilation hole 121 through which external air is introduced, and the first outlet 123 and the second outlet 124 through which air is discharged.

In one example, the door 20 may be equipped with the camera. The image filmed by the camera may be reproduced on the display 110, and the user may view an image of an inside of the cavity 11 or a space under the cooking appliance via the display 110. The camera may include a first camera 310, a second camera 210, and a third camera 230.

The first camera 310 may be disposed at an upper front portion of the display module 21 to film a space ahead of the cooking appliance.

The first camera 310 may film the user in front of the cooking appliance or an indoor space. Accordingly, the first camera 310 may be used for the user to make a video call with another person outside the main door or at another remote place using the display 110. The first camera 310 will be described in detail below.

The second camera 210 may be mounted at a lower portion of the outer panel 120 to film a state of a space under the door 20. Because the second camera 210 is mounted at the lower portion of the outer panel 120 such that a line of sight is directed to the space under the cooking appliance, it may film the heating cooking apparatus disposed under the cooking appliance. Alternatively, the second camera 210 may be utilized to monitor a state of the heating cooking appliance below the cooking appliance.

The user may observe the state of the heating cooking appliance and a cooked state of food on the heating cooking appliance by the image filmed by the second camera 210 and reproduced on the display 110.

The third camera 230 may be mounted on the frame 160, may be disposed to face the cavity 11, and may film the cavity 11. That is, a line of sight of the third camera 230 may be directed toward the cavity 11 to film a situation of the cavity 11. The user may observe a situation in which the food is cooked in the cavity 11 via the image filmed by the third camera 230.

The door 20 may include a latch 250 mounted at a side of the frame 160 and formed to partially protrude from the frame 160. The latch 250 may be formed in a structure that is hooked to a groove defined in the front panel 12 of the door 20. The latch 250 may stably maintain the closed state of the door 20.

FIG. 10 is an exploded perspective view of the door 20 according to an embodiment. FIG. 11 is a view of FIG. 10 in another direction. The cooling flow path 22 may include an inner panel 130, an air guide 140, and the blower 150.

The inner panel 130 may be disposed at the rear of the outer panel 120 and may be mounted on the outer panel 120. The air guide 140 to be described later may be mounted on the inner panel 130. The inner panel 130 may define a space in which air sucked into the door 20 flows together with the air guide 140.

The air guide 140 may be mounted on the inner panel 130, and may be coupled to the frame 160 to provide the space in which air introduced into the door 20 flows.

The air guide 140 may be disposed between the outer panel 120 and the inner panel 130, and may be coupled to the inner panel 130. The air guide 140 may guide the flow of air introduced into the door 20 from the outside and define the space in which air may flow.

The blower 150 may be mounted on the air guide 140. The blower 150 may forcibly allow air introduced into the air guide 140 to flow from a rear side to a front side of the air guide 140.

The shielding portion 23 may include the frame 160 and the choke member 170. The frame 160 may be disposed at the rear of the inner panel 130, may be coupled to the inner panel 130, and may have one side pivotably coupled to the main body 10. The door 20 may pivot as the frame 160 pivots to open and close the cavity 11 of the cooking appliance.

The frame 160 may be coupled to the inner panel 130 to form a flow path of air for cooling, and at the same time, may have a shielding structure for preventing the electromagnetic wave leakage, that is, the choke member 170, to form an inner surface of the door 20.

The choke member 170 may be disposed at the rear of the frame 160, may be coupled to the frame 160, and may block external emission of the electromagnetic wave generated from the main body 10. The choke member 170 may be formed in a substantially hollow quadrangular shape and may surround edges of the frame 160.

FIG. 12 is a perspective view illustrating the outer panel 120 according to an embodiment. FIG. 13 is a view of FIG. 12 in another direction. FIG. 14 is a view illustrating an inner panel and an air guide according to an embodiment. FIG. 15 is an exploded perspective view of FIG. 14.

Referring to FIG. 13, the door 20 may include the speaker 260 and the microphone 270. At least one speaker 260 may be mounted at a side of the outer panel 120. The speaker 260 may generate a voice, an alarm sound, and the like necessary for the operation of the cooking appliance. In addition, the speaker 260 may generate a voice, an alarm sound, and the like for the door 20 including the display 110 to function as the IoT hub.

The microphone 270 may be mounted at a lower portion of the outer panel 120 and may receive a user's voice. The user may input a voice command for manipulating the cooking appliance via the microphone 270. In addition, the microphone 270 may play a part of a role for the door 20 to function as the IoT hub.

In one example, a communication unit for communication may be disposed in the door. Because the door 20 functions as the IoT hub, it is appropriate that the communication unit disposed in the door 20 is equipped to perform various types of wired or wireless communication functions.

The outer panel 120 may include a first through-hole 120c and a second through-hole 120d. The first through-hole 120c may be defined at the side of the outer panel 120. The first through-hole 120c may be defined adjacent to a location where the speaker 260 is disposed. The first through-hole 120c may be formed in a mesh shape to allow the speaker 260 to be in communication with the outside and simultaneously to suppress the speaker 260 from being exposed to the outside.

The speaker 260 may be in communication with the outside of the outer panel 120 via the first through-hole 120c, thereby effectively transmitting the alarm and other voices to the user. Because the speaker 260 includes a pair of speakers, the first through-hole 120c may also include a pair of first through-holes defined at locations corresponding to the pair of speakers 260, respectively.

The second through-hole 120d may be defined to extend through the outer panel 120 at a lower portion of one side of the outer panel 120. A portion of the button device 300 mounted inside the outer panel 120 may be exposed to the outside of the outer panel 120 via the second through-hole 120d. The user may manipulate the button device 300 by being in contact with an exposed portion of the outer panel 120.

The outer panel 120 may have the first outlet 123 defined at an upper portion thereof and the second outlet 124 defined at a lower portion thereof. The first outlet 123 may be defined at the upper portion of the outer panel 120, and air flowing inside the door may be discharged to the outside by the blower 150. The second outlet 124 may be defined at the lower portion of the outer panel 120, and air flowing inside the door may be discharged to the outside by the blower 150.

The first outlet 123 may be defined at a location adjacent to an upper end of the display 110, and the second outlet 124 may be defined at a location adjacent to a lower end of the display 110. Accordingly, air forced to flow inside the door 20 by the blower 150 may be discharged to the outside at the locations adjacent to the upper end and the lower end of the display 110 via the first outlet 123 and the second outlet 124.

Air discharged via the first outlet 123 may form the air curtain above the door 20. In addition, air discharged via the second outlet 124 may form the air curtain below the door 20.

The air curtain refers to a means for blocking external air flow from penetrating into the door 20. In an embodiment, a boundary surface or a boundary area where the flow of air discharged from the inside of the door 20 via the first outlet 123 and the second outlet 124 forms a boundary with the external air flow may be referred to as the air curtain.

The air curtains formed by air discharged from the inside of the door 20 via the first outlet 123 and the second outlet 124 may suppress external air from penetrating into the door 20.

Because the heating cooking appliance is disposed under the cooking appliance, heat generated when the heating cooking appliance is used and oil vapor generated from the food being cooked may rise and penetrate the cooking appliance.

Heat transferred from the heating cooking apparatus to the cooking apparatus may damage a component of the door 20 disposed in the cooking apparatus. In particular, the display 110 and a component in which a circuit, a module, or the like related to the operation thereof is embedded may be vulnerable to heat.

In addition, oil vapor delivered from the food being cooked may be adhered to the door 20 disposed in the cooking appliance. Oil vapor may be adhered to a surface of the display 110 and degrade an image quality of the display 110, and may be adhered to a surface of other components mounted on the door 20 to damage such components.

In an embodiment, the air flow discharged to the outside of the door 20 via the first outlet 123 and the second outlet 124 defined in the door 20 may form the air curtains, so that heat and oil vapor rising from the heating cooking appliance disposed under the cooking appliance may be effectively blocked by the air curtains.

Accordingly, the various electronic components including the display 110 disposed on the door 20 may be effectively suppressed from being damaged or degraded in function by heat and oil vapor.

Referring to FIG. 14, the air guide 140 may include an inlet 141 and an exhaust port 142. The inlet 141 may be defined at an upper portion of the air guide 140, may allow external air to be introduced thereinto, and may include at least one inlet.

The inlet 141 may be defined at a location corresponding to the first ventilation hole 121 defined in the upper portion of the outer panel 120. Accordingly, external air may pass through the first ventilation hole 121 of the outer panel 120 and be introduced into the door 20 via the inlet 141.

The exhaust port 142 may be formed below the inlet 141 in the air guide 140, and the blower fan 152 may be disposed at a location overlapping the exhaust port 142 in the front and rear direction. The exhaust port 142 may be formed to extend through the air guide 140 in the front and rear direction of the door 20.

Accordingly, air may flow from the upper portion to a lower portion of the air guide 140 via the inlet 141, and may flow again via the exhaust port 142 in a changed direction from a rear space to a front space of the air guide 140.

The blower 150 may include a casing 151 and the blower fan 152. The casing 151 may be disposed in the exhaust port 142, may have a hollow defined therein, and may have the blower fan 152 mounted in the hollow.

The blower fan 152 may be rotatably mounted on the casing 151, and may allow air to flow from the rear space to the front space of the air guide 140. The blower fan 152 may rotate by receiving electricity to allow air to flow inside the door 20.

By the rotation of the blower fan 152, external air may be introduced into the door 20 via the inlet 141 and discharged to the outside of the door 20 via the first outlet 123 and the second outlet 124. The exhaust port 142 of the air guide 140 may be formed at a center of the casing 151 to correspond to a location, an area size, and a shape of the hollow in which the blower fan 152 is disposed.

FIG. 16 is a side cross-sectional view of the door 20 viewed in a direction 16-16 in FIG. 5. Hereinafter, the flow of air inside the door 20 will be described in detail with reference to FIG. 16. In FIG. 16, the flow of air is indicated by arrows.

As the blower fan 152 rotates, external air may flow into the door 20 via the inlet 141 of the air guide 140 and may flow to be discharged to the outside of the door 20 via the first outlet 123 and the second outlet 124.

Air forced to flow by the blower fan 152 may specifically have a flow path as follows.

Air may be introduced into the door 20 from the first ventilation hole 121 of the outer panel 120 and the inlet 141 defined at a location corresponding thereto. Air introduced into the door 20 may flow in a downward direction of the door 20 and may be introduced into the blower fan 152.

Air may pass through the blower fan 152 in the front and rear direction of the door 20. In this regard, air may pass through the exhaust port 142 of the air guide 140 while passing through the blower fan 152. The flow direction of air in the blower fan 152 may be changed from the vertical direction of the door 20 to the front and rear direction.

Because a front space of the exhaust port 142 is blocked by the display 110, air that has passed through the exhaust port 142 may be branched in the vertical direction in a space ahead of the air guide 140.

A portion of the branched air may flow in the upward direction of the door 20 and may be discharged to the first outlet 123. The other portion of the branched air may flow in the downward direction of the door 20 and be discharged to the second outlet 124.

Air branched from the first outlet 123 and the second outlet 124 may surround the entire door 20. The branched air may particularly surround the front surface of the door 20. Because of such a structure, air discharged from the first outlet 123 and the second outlet 124 forms the air curtains on the door 20, thereby effectively suppressing heat and oil vapor generated from the heating cooking appliance disposed under the cooking appliance from penetrating into the door 20.

In addition, because of the above-described air flow structure inside the door 20, air introduced into the door 20 may flow through the entire inside of the door 20. For example, air may flow in an entire space defined by the rear surface of the display 110 and the outer panel 120.

Accordingly, air flowing inside the door 20 may cool the entire rear surface of the display 110 and effectively cool the components mounted on the outer panel 120 and other portions of the door 20.

In particular, the outer panel 120 may be equipped with components that generate heat, such as the speaker 260, the microphone 270, and the printed circuit board. Such heating components may be arranged over the entire outer panel 120. Therefore, air may effectively cool such heating components while flowing through the entire inside of the outer panel 120.

As shown in FIG. 16, the first ventilation hole 121 through which air is introduced and the inlet 141 may be in communication with each other. As the blower fan 152 rotates, external air may be introduced into the air guide 140 via the first ventilation hole 121 and the inlet 141 and flow toward the blower 150 via a space defined by the inner panel 130 and the air guide 140.

Air may flow toward the blower fan 152 of the blower 150 in a space defined by the frame 160. Air may pass through the blower fan 152 and hit the rear surface of the display 110 disposed to face the blower fan 152 to cool the display 110.

Air that has passed through the blower fan 152 may hit the rear surface of the display 110, and then the flow thereof may be branched in the upward and downward directions of the display 110. Air directed to an upper side of the display 110 may be discharged to the outside of the door 20 via the first outlet 123 defined at the upper side of the outer panel 120. Air directed to the lower side of the display 110 may be discharged to the outside of the door 20 via the second outlet 124 defined at the lower side of the outer panel 120.

In an embodiment, air flowing inside the door 20 may cool the entire front surface of the display 110 while being discharged via the first outlet 123. In addition, air flowing inside the door 20 may effectively cool the rear surface of the display 110 and the heating components mounted inside the door 20.

The exhaust port 142 may be formed at a center of the air guide 140. The casing 151 may have the hollow having a location, a size, and a shape corresponding to those of the exhaust port 142, and the blower fan 152 may be disposed in the hollow. The casing 151 may be disposed to be located at a location where the hollow thereof and the exhaust port 142 of the air guide 140 correspond to each other, and may be mounted on one surface of the air guide 140.

A hollow 130a may be defined in the inner panel 130. Because the hollow 130a of the inner panel 130 is closed by the frame 160, air introduced via the inlet 141 may not leak into the hollow 130a of the inner panel 130. Accordingly, the inner panel 130 and the frame 160 may form together an air flow path through which air that cools the inside of the door 20 flows.

FIG. 17 is an enlarged view of a portion 17 in FIG. 16. The door 20 may include a front coupling portion 24 disposed upward of the display 110, protruding forwardly of the door 20, and coupled to the outer panel 120. A gap having a predetermined size may be formed between a lower portion of the front coupling portion 24 and the front surface of the display 110, and such a gap may serve as a discharge path for air that cools the inside of the door 20.

The front coupling portion 24 may include a sensing module 310 and a panel 320. The sensing module 310 may be disposed upward and forward of the display module 21, may sense an external situation, and may include various types of sensing devices.

The panel 320 may be disposed upward and forward of the display module 21. The panel 320 may cover the sensing module 310. Because the panel 320 covers the sensing module 310, the panel 320 may form an outer shape of the front coupling portion 24. In this regard, the sensing module 310 may be accommodated in the panel 320.

In another embodiment, the sensing module 310 may not be accommodated in the panel 320, but may be disposed at the rear of the panel 320.

The panel 320 may be disposed to overlap the display module 21. In another embodiment, the panel 320 may be disposed above the display module 21 without overlapping the display module 21.

The panel 320 may protrude forward of the display module 21. In another embodiment, the panel 320 may not protrude with respect to the display module 21, and may be disposed such that a front surface thereof is on the same plane as a front surface of the display module 21 or lies rearward of the front surface of the display module 21.

The panel 320 may be disposed such that a longitudinal direction thereof is directed in the lateral direction of the door 20, and may be formed in an overall long rod shape. The panel 320 may guide the flow direction of air discharged from the first outlet 123. For example, the panel 320 may change the flow direction of air discharged from the first outlet 123 to the downward direction.

To this end, the panel 320 may be disposed in front of the first outlet 123. The panel 320 may be disposed to overlap the first outlet 123 in the front and rear direction. Air flowing inside the door 20 may be discharged in the forward direction of the door 20 via the first outlet 123 located at the upper portion of the door 20.

In this regard, the panel 320 may block the first outlet 123 from the front, and air discharged from the first outlet may be blocked by the panel 320 and the flow direction thereof may be changed from the forward direction to the downward direction of the door 20.

In addition, a lower end of the panel 320 may protrude further downward than a lower end of the first outlet 123. Because of such a structure, air discharged from the first outlet 123 may collide with the panel 320 and may be guided by the panel 320, so that the flow path thereof may be changed to the downward direction.

Air discharged from the first outlet 123 in the forward direction may flow in the downward direction by the panel 320.

Air discharged in the forward direction from the first outlet 123 may collide with a rear surface of the panel 320 and flow in a changed direction toward an open lower portion between the panel 320 and the first outlet 123. In addition, because the lower end of the panel 320 further protrudes in the downward direction than the lower end of the first outlet 123, air may be guided by the lower end of the panel 320 to flow, and then may continue to flow in the downward direction of the door 20 for a certain period of time after exiting the door 20.

Air forced to flow by the blower fan 152 may be introduced from the inlet 141, flow in the downward direction of the door 20, be introduced into the blower fan 152, pass the blower fan 152 in the front and rear direction of the door 20, and diverge in the vertical direction at a location in front of the air guide 140. Further, a portion of air may flow in the upward direction of the door 20 and be discharged to the first outlet 123, and the rest of air may flow in the downward direction of the door 20 and be discharged to the second outlet 124.

In this regard, air discharged from the first outlet 123 may be guided by the panel 320 to flow downward, and at least a portion thereof may comes into contact with the front surface of the display 110. In addition, at least a portion of air discharged from the second outlet 124 may flow forward of the door 20.

Air discharged from the second outlet 124 may flow forward of the door 20, and thus may serve as the air curtain that blocks oil vapor and other foreign substances rising from the heating cooking appliance below the cooking appliance from being adhered to the front surface of the display 110.

Air discharged from the first outlet 123 may form the air curtain like air discharged from the second outlet 124 to prevent oil vapor or the like from being adhered to the front surface of the display 110.

In addition, air discharged from the first outlet 123 may be changed in the flow direction by the panel 320 and discharged in the downward direction of the door 20, so that at least a portion thereof may come into contact with the front surface of the display 110.

Because of such a structure, air discharged from the first outlet 123 may directly come into contact with the front surface of the display 110 to cool the front surface of the display 110. Therefore, the front surface and the rear surface of the display 110 are both cooled by air, so that cooling efficiency may be significantly improved compared to a case in which only the rear surface of the display 110 is cooled.

FIG. 18 is a perspective view illustrating the bottom panel 15 and the lighting unit 25 according to an embodiment. FIG. 19 is a view of FIG. 18 in another direction. FIG. 20 is an exploded perspective view of the bottom panel 15 and the lighting unit 25.

The main body 10 of the cooking appliance may include the bottom panel 15 and the lighting unit 25. The bottom panel 15 may be installed at a lower portion of the main body 10 and may cover a lower portion of the main body 10.

The lighting unit 25 may be installed on the bottom panel 15 and may irradiate light in the downward direction of the cooking appliance. The lighting unit 25 may be disposed such that a longitudinal direction thereof is parallel to the lateral direction of the main body 10.

The heating cooking apparatus is disposed under the cooking appliance, and lighting is required when the user uses the heating cooking apparatus. Accordingly, the lighting unit 25 may be disposed on the bottom panel 15 of the cooking appliance and irradiate light toward the heating cooking apparatus located below, thereby providing convenience to the user.

The bottom panel 15 may include a lighting mounting hole 15a defined such that a longitudinal direction thereof is parallel to a lateral direction of the bottom panel 15, and in which the lighting unit 25 is mounted. The lighting mounting hole 15a may be defined in the bottom panel 15 in a shape corresponding to the lighting unit 25.

As the lighting unit 25 is mounted in the lighting mounting hole 15a, a portion of the lighting unit 25 having a predetermined volume may be embedded in the main body 10. Accordingly, the lighting unit 25 is inserted into the main body 10 to suppress the lighting unit 25 from protruding downward from the bottom panel 15, thereby improving overall aesthetics of a lower side of the main body 10.

The bottom panel 15 may include the suction unit 14 that is formed to extend through the bottom panel 15 and sucks the foreign substances rising from below the cooking appliance. In this regard, the lighting unit 25 may be disposed in front of the suction unit 14.

Because the suction unit 14 sucks the foreign substances that may be harmful to humans, it may be appropriate to be disposed as far away as possible from the user. In addition, the lighting portion 25 and the lighting mounting hole 15a need to be formed at a location avoiding the suction portion 14 in the bottom panel 15.

Accordingly, the suction unit 14 may be disposed at a rear side of the bottom panel 15, and the lighting unit 25 may be disposed in front of the suction unit 14. Accordingly, the suction unit 14 may be disposed at the location as far away as possible from the user, and a space in which the lighting unit 25 and the lighting mounting hole 15a are disposed may be secured in the bottom panel 15.

FIG. 21 is a side view illustrating the lighting unit 25 according to an embodiment. FIG. 22 is an exploded perspective view illustrating the lighting unit 25 according to an embodiment. FIG. 23 is a view of FIG. 22 in another direction.

The lighting unit 25 may include a light source board 410. The lighting unit 25 may include a diffusion plate 420. The light source board 410 may have a plurality of light sources 411 aligned to be spaced apart from each other. The light source board 410 may include various elements and circuits for operating the light sources 411 together with the light sources 411.

The light source 411 may be equipped as, for example, an LED. Light irradiated from the light source 411 may be irradiated downward from the lower portion of the main body 10 toward the heating cooking apparatus located below.

The light source 411 may include a plurality of light sources, and the plurality of light sources 411 may be spaced apart from each other and aligned in parallel with a longitudinal direction of the lighting unit 25. Because of such a structure, light irradiated from the light source board 410 may form point illumination as a whole.

The point illumination is not visually beautiful, and is able to cause inconvenience to the user. Therefore, it is necessary to convert the point illumination from the light source board 410 into surface illumination that is uniform and diffused in the lighting unit 25. To this end, the lighting unit 25 may include the diffusion plate 420.

The diffusion plate 420 may be disposed under the light source board 410 and may diffuse light irradiated from the light sources 411. The diffusion plate 420 may be formed in a shape corresponding to a bottom surface of the light source board 410, and may cover all of the light sources 411 from under the light sources 411.

Accordingly, light irradiated from the light sources 411 may be diffused while passing through the diffusion plate 420, may be changed to the surface illumination having uniform illuminance when viewed in the entire diffusion plate 420, and may be irradiated in the downward direction of the main body 10.

In an embodiment, because the diffusion plate 420 is disposed, light irradiated from the light source board 410 may be changed to the surface illumination while passing through the diffusion plate 420. Accordingly, the lighting unit 25 may provide a visually beautiful and convenient lighting to the user.

The lighting unit 25 may include a cover glass 430. The lighting unit 25 may include a lower cover 440. The cover glass 430 may be disposed under the diffusion plate 420 and may close an interior of the lighting unit 25. The cover glass 430 may prevent the diffusion plate 420 and the light source board 410 inside the lighting unit 25 from being exposed to the outside, and may suppress the foreign substances from being introduced into the lighting unit 25.

The cover glass 430 may be made of a material such as glass or plastic, and may be formed to be transparent or translucent. The cover glass 430 may be mounted on the lower cover 440.

The lower cover 440 may be disposed under the cover glass 430, may have the cover glass 430 mounted thereon, and may be coupled to the bottom panel 15. The lower cover 440 is a component disposed at a lowermost side of the lighting unit 25, but is able to be coupled to the bottom panel 15 such that a degree of protrusion from the bottom panel 15 is not great as a whole.

Because of such a structure, when the bottom panel 15 of the cooking appliance is viewed from the outside, a bottom surface of the bottom panel 15 may be viewed in a flat shape as a whole, thereby increasing visual aesthetics for the user.

The lower cover 440 may include an exposure hole 443 exposing the cover glass 430 to the outside. In this regard, an area size of the exposure hole 443 may be smaller than an area size of the cover glass 430.

Accordingly, when the lower cover 440 is coupled to the bottom panel 15, the cover glass 430 may not be deviated to the outside via the exposure hole 443. Because of such a structure, as the lower cover 440 is coupled to the bottom panel 15, the components of the lighting unit 25 may be stably mounted on the bottom panel 15 without being deviated to the outside.

FIG. 24 is a plan view of a portion of a reflector 450 according to an embodiment. FIG. 25 is a perspective view illustrating a portion of the lower cover 440 according to an embodiment. FIG. 26 is a perspective view illustrating a state in which the diffusion plate 420, the cover glass 430, and the lower cover 440 are assembled and the light source board 410 is disposed.

The lighting unit 25 may include the reflector 450 that is disposed on the light source board 410, accommodates the light source board 410 therein, and reflects light irradiated from the light sources 411 to be directed downward.

The reflector 450 may be formed of an opaque material and may accommodate the light source board 410 therein, so that all of side surfaces and top surfaces of the plurality of light sources 411 disposed on the light source board 410 may be surrounded by the reflector 450.

Accordingly, light irradiated from the light sources 411 may not travel in the lateral direction and an upward direction of the light source board 410, but may be reflected, and may entirely travel in the downward direction. Accordingly, light efficiency of the lighting unit 25 may be improved.

The reflector 450 according to another embodiment may be constructed to reflect light from the light sources 411 better by forming a mirror layer on a wall surface located inside where the light source board 410 is accommodated.

The light source board 410 may be accommodated in the reflector 450, and the reflector 450 itself may be coupled to another component to form an entirety of the lighting unit 25. Therefore, a structure for coupling with another component of the lighting unit 25 may be disposed on the reflector 450. Such a structure will be described in detail below.

The reflector 450 may include a first part 451 and a second part 452. The first part 451 may protrude and define a space for accommodating the light source board 410. The light source board 410 may be placed in the space defined in the first part 451, and may be coupled to the first part 451 by a coupling mechanism such as a screw.

The second part 452 may extend from both ends of the first part 451 and may be coupled to a top surface of the bottom panel 15. As the second part 452 is coupled to the top surface of the bottom panel 15, the entire lighting unit 25 may be mounted in the bottom panel 15.

In one example, the lower cover 440 may be coupled to the second part 452 of the reflector 450. To this end, the lower cover 440 may include at least one of a first catching protrusion 441 and a first bendable protrusion 442.

The first catching protrusion 441 may protrude upward from an edge of the lower cover 440 and may be inserted through the bottom panel 15 and the second part 452. The lower cover 440 may be coupled to both the bottom panel 15 and the second part 452 of the reflector 450 by the first catching protrusion 441.

The first catching protrusion 441 may include a plurality of first catching protrusions spaced apart from each other in a longitudinal direction of the lower cover 440 at the edge of the lower cover 440. In addition, the first catching protrusions 441 may be formed at both edges of the lower cover 440.

The first bendable protrusion 442 may protrude upward from the edge of the lower cover 440 and may be bent to be coupled to the diffusion plate 420. Similar to the first catching protrusion 441, the first bendable protrusion 442 may include a plurality of first bendable protrusions spaced apart from each other in the longitudinal direction of the lower cover 440 at the edge of the lower cover 440. In addition, the first bendable protrusions 442 may be formed at both edges of the lower cover 440.

The diffusion plate 420 may include a first bendable protrusion coupling portion 421 protruding from an edge thereof and coupled with the bent first bendable protrusion 442. The number and locations of first bendable protrusion coupling portions 421 may correspond to the number and locations of the first bendable protrusions 442.

Referring to FIG. 26, the lower cover 440 and the diffusion plate 420 may be coupled to each other with the cover glass 430 interposed therebetween. In this regard, the first bendable protrusion 442 of the lower cover 440 may be bent and be in contact with one surface of the first bendable protrusion coupling portion 421 of the diffusion plate 420. Accordingly, the lower cover 440 and the diffusion plate 420 may be stably coupled to each other, and the cover glass 430 disposed between the lower cover 440 and the diffusion plate 420 may also be assembled.

FIG. 27 is a perspective view illustrating a portion of the bottom panel 15. The bottom panel 15 may include a first bent portion 401 and a first insertion hole 402.

The first bent portion 401 may be formed by being bent at an edge of the lighting mounting hole 15a. The first bent portion 401 may be constructed such that the first catching protrusion 441 is inserted thereinto and caught thereinto. The first insertion hole 402 may be defined in the first bent portion 401, and the first catching protrusion 441 may be inserted thereinto.

In addition, the bottom panel 15 may include a second catching protrusion 403 and a second bendable protrusion 404. The second catching protrusion 403 may protrude upward from the edge of the lighting mounting hole 15a and may be inserted through the second part 452. The second catching protrusion 403 may include a plurality of second catching protrusions spaced apart from each other in a longitudinal direction of the lighting mounting hole 15a at the edge of the lighting mounting hole 15a.

The second bendable protrusion 404 may protrude upward from the edge of the lighting mounting hole 15a, and may be bent to be coupled to the second part 452. Similar to the second catching protrusion 403, the second bendable protrusion 404 may include a plurality of second bendable protrusions spaced apart from each other in the longitudinal direction of the lighting mounting hole 15a at the edge of the lighting mounting hole 15a.

For example, the second catching protrusion 403 and the second bendable protrusion 404 may be formed at locations adjacent to a pair of long sides of the lighting mounting hole 15a, and the second catching protrusion 403 may be disposed at a location adjacent to one long side and the second bendable protrusion 404 may be disposed at a location adjacent to the other long side.

FIG. 28 is a perspective view illustrating a state in which the lighting unit 25 is coupled to the bottom panel 15. FIG. 29 is a plan view of FIG. 28. FIG. 30 is a view of FIG. 28 in another direction.

Referring to FIG. 30, in a state in which the bottom panel 15 and the reflector 450 are assembled, the second bendable protrusion 404 may be bent and be in contact with an outer surface of the second part 452 of the reflector 450. Because of such a structure, the bottom panel 15 and the reflector 450 may be firmly and stably coupled to each other.

In one example, an end of the first catching protrusion 441 may include a bent first catching bent portion 4411, and the first catching bent portion 4411 may be caught by the first bent portion 401.

The first catching protrusion 441 of the lower cover 440 may be inserted into the first insertion hole 402 of the bottom panel 15 and pass through the bottom panel 15. In this regard, the first catching bent portion 4411 formed at the end of the first catching protrusion 441 may be caught by the first bent portion 401 of the bottom panel 15. Because of such a structure, the lower cover 440 may be coupled to the bottom panel 15 in a hook manner.

The second part 452 of the reflector 450 may include a first sub-insertion hole 4521 defined at a location corresponding to the first catching protrusion 441 and into which the first catching protrusion 441 is inserted. The first catching protrusion 441 may pass through the first sub-insertion hole 4521, and a portion thereof including the first catching bent portion may be exposed to the outside.

The second part 452 may include a second insertion hole 4522 defined at a location corresponding to the second catching protrusion 403 and into which the second catching protrusion 403 is inserted. An end of the second catching protrusion 403 may include a bent second catching bent portion 4031. The second catching bent portion 4031 may be caught by the second part 452 after passing through the second insertion hole 4522.

The second catching protrusion 403 of the bottom panel 15 may be inserted into the second insertion hole 4522 of the second part 452 of the reflector 450 and pass through the reflector 450. In this regard, the second catching bent portion 4031 formed at the end of the second catching protrusion 403 may be caught by the second part 452 of the reflector 450.

That is, the second catching bent portion 4031 may come into contact with the outer surface of the second part 452 and be caught by the second part 452. Because of such a structure, the reflector 450 may be coupled to the bottom panel 15 in the hook manner.

In one example, the second part 452 may include a protrusion placement recess 4523 defined to be recessed from the end thereof and defined at a location corresponding to the second bendable protrusion 404. The number of protrusion placement recesses 4523 may correspond to the number of second bendable protrusions 404.

The protrusion placement recess 4523 may prevent the second part 452 and the second bending protrusion 404 from interfering with each other. Accordingly, the second bendable protrusion 404 may be bent after passing through the protrusion placement recess 4523 to be coupled to the second part 452.

In an embodiment, both the lower cover 440 and the reflector 450 may assemble the components of the lighting unit 25 and may be stably coupled to the bottom panel 15 at the same time by comprehensively using the bending method and the hook method.

In an embodiment, the lower cover 440 may include the first catching protrusion 441 and the first bendable protrusion 442. The bottom panel 15 may include the second catching protrusion 403 and the second bendable protrusion 404. The lighting unit 25 may be easily assembled, and at the same time, may be firmly and stably coupled to the bottom panel 15 by such catching protrusions and bendable protrusions. In addition, because of such a structure, the assembly of the lighting unit 25 and the coupling of the bottom panel 15 may be easily performed.

The present disclosure relates to a cooking appliance including a digital controller door disposed at a front surface of the cooking appliance to control the cooking appliance.

According to the present disclosure, a door of a microwave oven disposed on top of an oven or a gas stove is configured to have an LCD screen, and the Android of the LCD screen and the microcomputer of the microwave oven cooperate with each other, and the LCD components operate or control specific functions based on various operating/external environments of the microwave oven.

The digital controller door of the present disclosure may be coupled to the cooking appliance to open and close the inside of the cooking appliance. One embodiment of the cooking appliance of the present disclosure is a microwave oven. However, the present disclosure is not limited thereto. An example of the cooking appliance including the digital controller door of the present disclosure may include each of various cooking appliances which includes a door equipped with a display such as an LCD that provides various user interfaces such as a touch screen, and can store the food therein and cook the food.

FIG. 31 is a conceptual diagram of a cooking appliance including a digital controller door according to an embodiment of the present disclosure.

The cooking appliance 1000 includes a digital controller door 600 at a front surface thereof. The digital controller door 600 includes one or two or more displays, and the display of the digital controller door 600 may display information about the inside of the cooking appliance 1000 or information related to an operation thereof to the user. The display of the digital controller door 600 may provide a touch input interface for receiving a predetermined command from the user.

A manner in which the digital controller door 600 is opened includes an embodiment 1000a, 1000b, or 1000c. 1000a shows an embodiment in which the digital controller door 600 pivots around a left side of the cooking appliance 1000a to open the inside of the cooking appliance 1000a. 1000b shows an embodiment in which the digital controller door 600 pivots around a top side of the cooking appliance 1000b to open the inside of the cooking appliance 1000b. 1000c shows an embodiment in which the digital controller door 600 pivots around a bottom side of the cooking appliance 1000c to open the inside of the cooking appliance 1000c.

A display 660 may be mounted on the front surface of the digital controller door 600 to provide various information to a user. The user may know the cooking state of the cooked food on the display 660. The display 660 may be embodied as a LCD. However, embodiments of the present disclosure is not limited thereto, and the display 660 may include various display panels. In addition, a touch panel for touch input may be coupled to the display 660.

The digital controller door 600 controls the operation of the cooking appliance 1000 and outputs various information. The cooking appliance 1000 performs cooking using microwaves or heater heat. Accordingly, a digital controlling function provided by the digital controller door 600 and a cooking function of the cooking appliance 1000 are provided in different ways and in different areas.

The digital controller door 600 of the present disclosure may serve as a kind of a hub. That is, the digital controller door 600 may serve as a hub of another home appliance and display information transmitted from another home appliance on the display 660. In this process, the user may obtain other information other than the cooking food on the display 660. In addition, the user may input a command necessary for cooking and various other commands to the display 660 in a touch manner.

To this end, in accordance with the present disclosure, a method and a configuration in which the digital controller door 600 and the cooking appliance 1000 respectively include independent control components, and these control components cooperate with each other to control the function of the cooking appliance will be described.

FIG. 32 is a diagram illustrating components of a digital controller door and components of a functional unit according to an embodiment of the present disclosure. Each of the components is conceptually disposed and is not limited to a specific physical location or material.

The digital controller door 600 may operate as an Internet-of-things hub. The digital controller door 600 may include an OS controller 700. In addition, the digital controller door 600 may include a camera 610. In addition, the digital controller door 600 may include a communicator 620. In addition, the digital controller door 600 may include a speaker/microphone 630. In addition, the digital controller door 600 may include a sensor 640. In addition, the digital controller door 600 may include the display 660. In addition, the digital controller door 600 may include an application 670. In addition, the digital controller door 600 may include a door fan 680. The door fan may be embodied as a direct current (DC) fan and cools the heat of the digital controller door 600. In particular, the door fan 680 cools heat generated from the display 660.

Hereinafter, the OS controller 700, the camera 610, the communicator 620, the speaker/microphone 630, the sensor 640, the display 660, the application 670, and the door fan 680 are referred to as components of the digital controller door 600

The functional unit 500 includes an AC input unit 510, a power supply 520, a function controller 550, a cooking appliance function provider 560, an inside lamp 570, an outside lamp 580, a ventilation fan 590, etc. The functional unit 500 and the digital controller door 600 are logically configured for the description of the present disclosure. The functional unit 500 may be implemented as a body 1010 illustrated in FIG. 34. Accordingly, the functional unit 500 may further include various physical components necessary for implementation as the body 1010 in addition to the components illustrated in FIG. 32.

The OS controller 700 controls various components of the digital controller door 600.

In addition, the OS controller 700 transmits a predetermined signal to the function controller 550, and allows the function controller 550 to control the performance of a specific function of the cooking appliance 1000. In addition, the function controller 550 may transmit a signal to the OS controller 700. This allows the function controller 550 to inform the OS controller 700 of a result related to the performance of a specific function of the cooking appliance 1000. The OS controller 700 may operate based on a specific OS (e.g., Android).

According to an embodiment, the function controller 550 and the OS controller 700 may operate independently and may communicate a predetermined signal with each other when there is information to be notified to each other. A type of signal may be based on various communication protocols such as wired communication or wireless communication. According to an embodiment, when the OS controller 700 receives information from the user and is instructed to perform a specific function of the cooking appliance, the OS controller 700 may transmit a specific signal to the function controller 550. In this case, the function controller 550 operates the functional unit 500, for example, the body 1010.

The function controller 550 may be embodied as a microcomputer for generating a signal for operating the functional unit 500, for example, the body 1010.

The camera 610 may be disposed on the digital controller door to photograph the outside of the cooking appliance 1000, photograph the surroundings, or photograph a cooking space inside the cooking appliance 1000.

In addition, the camera 610 may be disposed inside the digital controller door 600. The camera 610 may photograph the inside of the cooking appliance 1000 to allow the user to check the cooking state of the food stored therein.

Accordingly, the camera 610 may be disposed to face outwardly of the digital controller door 600 (toward the user) and to face inwardly of the digital controller door 600 (toward the inside of the cooking appliance). In this case, the display 660 may output an image obtained by photographing the outside out of the cooking appliance or the inside of the cooking appliance based on the cooking state or a state of the function performed by the digital controller door 600.

The communicator 620 may perform various types of wired or wireless communication functions. The communicator may communicate with another device (e.g., an external server, a hub disposed in a home, or another home appliance) using a communication protocol such as Wi-Fi, Bluetooth, or the like.

The speaker/microphone 630 may generate a voice, an alarm sound, etc. necessary for the operation of the cooking appliance 1000, and may receive a predetermined external voice command or an external sound. The speaker/microphone 630 may be integral with each other or may be disposed at different positions.

The sensor 640 senses an environment outside or inside the cooking appliance 1000. For example, the sensor 640 may include a temperature sensor, an illuminance sensor, a human sensor, a humidity sensor, etc.

The display 660 outputs visual information to be provided to a user. The information provided from the display 660 includes a cooking function or state of the cooking appliance 1000 in operation, an interface for controlling the cooking appliance 1000, and information on a surrounding environment in which the cooking appliance 1000 is disposed.

In addition, when the digital controller door 600 operates as an Internet-of-things hub, the display 660 may display various information in addition to cooking related information. In addition, the display 660 may convert a user's touch into an input signal.

The application 670 stores therein various application programs as executed by the digital controller door 600, and the OS controller 700 may execute the application programs stored in the application 670 and may display the execution results on the display 660.

The door fan 680 embodied as the direct current fan is configured to cool heat generated in various electronic devices related to a digital controller door. The door fan 680 may cool the heat generated from the display 660 or the OS controller 700.

The OS controller 700 may download various application programs through the communicator 620 and store and install the application programs in the application 670.

The application program according to an embodiment of the present disclosure includes an application program directly or indirectly related to the operation or function of the cooking appliance 1000, such as an application program for controlling the cooking of the cooking appliance 1000, an application program related to an image or a video to be displayed during the operation of the cooking appliance 1000, etc. In this case, the OS controller 700 may control a function of the cooking appliance 1000 by controlling the function controller 550 using the application program.

In addition, the application program according to an embodiment of the present disclosure includes an application program necessary for the digital controller door 600 to operate as the Internet of Things hub.

The AC input unit 510 constituting the functional unit 500 receives power required for the cooking appliance 1000 to operate. The supplied power is provided to the function controller 550 and the OS controller 700 through the power supply 520.

The function controller 550 controls the functions of the cooking appliance 1000. In this regard, the function controller 550 receives a signal from the OS controller 700 and controls the functions of the cooking appliance 1000. The function controller 550 may control an operation of each of the cooking appliance function provider 560, the inside lamp 570, the outside lamp 580, the ventilation fan 590, and the thermistor 595 according to the signal received from the OS controller 700. Hereinafter, the cooking appliance function provider 560, the inside lamp 570, the outside lamp 580, the ventilation fan 590, and the thermistor 595 are referred to as components of the functional unit 500.

The cooking appliance function provider 560 generates microwaves or heater heat to cook food stored in the cooking appliance 1000.

The inside lamp 570 is disposed inside the cooking appliance 1000 that is opened and closed by the digital controller door 600. When the digital controller door 600 is opened or closed, the inside lamp 570 may be turned on and off. Alternatively, when the cooking appliance 1000 is cooking the food, the inside lamp 570 may be turned on so that the internal camera may capture an image thereof.

The outside lamp 580 is disposed at a lower end or an upper end of the cooking appliance 1000. When the cooking appliance 1000 is disposed on top of a separate cooktop, the outside lamp 580 may be disposed at a lower end of the cooking appliance 1000.

The ventilation fan 590 discharges heat generated from the cooktop to the outside.

The thermistor 595 is a component disposed in the functional unit 500 to sense a temperature. One or more thermistors 595 may be disposed at the cooking appliance 1000.

According to an embodiment of the present disclosure, the thermistor 595 may provide information on the sensed temperature to the function controller 550. According to another embodiment of the present disclosure, the thermistor 595 may be included in the sensor 640, and in this case, information on the sensed temperature may be provided to the OS controller 700 that controls the sensor 640.

The food stored in the cooking appliance 1000 is cooked via the operation of the cooking appliance function provider 560. Even in this process, the function controller 550 and the OS controller 700 may communicate information with each other per a preset time interval.

The OS controller 700 provides a UI/UX function. In addition, the OS controller 700 transmits a predetermined signal to the function controller 550, and the function controller 550 controls the operation of the cooking appliance 1000, for example, the body 1010 or the functional unit 500. In addition, the function controller 550 may control an operation of the cooking appliance function provider 560 and provide the OS controller 700 with an information value generated therefrom.

Accordingly, the control flow of the OS controller 700 and the function controller 550 is configured such that the OS controller 700 transmits a predetermined signal to the function controller 550 and then receives a predetermined control result from the function controller 550.

The OS controller 700 and the function controller 550 may communicate with each other in a wired or wireless manner. The OS controller 700 and the function controller 550 may communicate with each other using various communication protocols, and embodiments of the present disclosure are not limited to a specific communication protocol.

As illustrated in FIG. 32, a communication link via which the function controller 550 transmits predetermined data to the OS controller 700 or performs control is referred to as a F_O link or an uplink. A communication link via which the OS controller 700 transmits predetermined data to the function controller 550 or performs control is referred to as an O_F link or a downlink. However, embodiments of the present disclosure are not limited to a specific name or a direction such as upward/downward, and the links may be distinguished from each other based on a direction of data transmission between the components 550 and 200.

In an embodiment of the present disclosure, the link may physically use one or more lines or may use one or more communication media. In addition, in accordance with the present disclosure, a name is separately given to each data transmission direction in order to distinguish logically the data transmission directions from each other.

According to an embodiment of the present disclosure, in the case of the wired communication, the OS controller 700 and the function controller 550 may communicate with each other using a communication protocol such as Universal asynchronous receiver/transmitter (UART) and Universal Serial Bus (USB).

According to an embodiment of the present disclosure, in the case of the wireless communication, the OS controller 700 and the function controller 550 may communicate with each other using a communication protocol such as Zigbee, Wi-Fi, and Bluetooth.

Each of the OS controller 700 and the function controller 550 may include a separate memory (internal memory), and may store, in the memory, function result information or error information generated in the process of performing a function.

FIG. 33 is a diagram illustrating categories of functions performed by an OS controller and a function controller according to an embodiment of the present disclosure. Each function includes a case in which each of the controllers 200 and 550 performs a corresponding function.

Each of the controllers 200 and 550 may perform the functions simultaneously or sequentially.

The function controller 550 controls the functional unit 500 that provides a cooking function. The operating system (OS) controller 700 transmits a signal to the function controller 550. The function controller 550 instructs an operation of the functional unit 500. The operating system (OS) controller 700 controls the digital controller door 600 that provides a human interface.

The functions performed by the function controller 550 include cooking function execution F_COOK. In addition, the functions performed by the function controller 550 include data acquisition F_DATA_COL of data generated in the cooking process. In addition, functions performed by the function controller 550 include F_element monitoring F_ELE_MONITORING. In addition, functions performed by the function controller 550 include communication F_COM with the OS controller 700. In addition, functions performed by the function controller 550 include OS controller monitoring F_OS_MONITORING. The OS controller 700 and the function controller 550 may operate independently, and may inform the state or operation status of each component via transmission and reception of signals to and from each other.

In the cooking function execution F_COOK, the function controller 550 controls the cooking appliance function provider 560 so that the cooking appliance 1000 may perform cooking. Alternatively, in addition to cooking such as heating, a function in which the function controller 550 controls the operation of the inside lamp 570, the outside lamp 580, and the ventilation fan 590 may be included in the cooking function execution F_COOK.

The function of the data acquisition F_DATA_COL of the data generated in the cooking process is a function of the function controller 550 collecting or acquiring various result values calculated by the components of the functional unit 500 or data related to the current state in the cooking function execution F_COOK process.

The F_element monitoring (F_ELE_MONITORING) refers to a function in which the function controller 550 monitors components of the functional unit 500. The function controller 550 may monitor whether each component operates properly or whether each component operates according to a previous instruction to perform a function.

The communication F_COM function with the OS controller means that the function controller 550 provides data obtained in F_DATA_COL, F_ELE_MONITORING, etc. to the OS controller 700.

The OS controller monitoring F_OS_MONITORING function refers to a function in which the function controller 550 transmits a predetermined packet to the OS controller 700 to check whether the OS controller 700 is operating properly.

The F_COM and F_OS_MONITORING functions may be implemented as one function. That is, even when the cooking function is not performed, the function controller 550 transmits the data obtained through the F_ELE_MONITORING to the OS controller 700. The function controller 550 may check whether the OS controller 700 is in a normal state or an abnormal state based on whether the OS controller 700 has transmitted an acknowledgement (ACK) response to the transmitted data.

The functions performed by the OS controller 700 include a human-interface HUMAN_IF. In addition, the functions performed by the OS controller 700 include function controller control and monitoring COOK_CONT_MON. In addition, the functions performed by the OS controller 700 include O_element monitoring O_ELE_MONITORING. In this regard, one embodiment of the function controller control and monitoring COOK_CONT_MON is that the OS controller 700 transmits a predetermined signal to the function controller 550 so that the function controller 550 may control the functional unit 500, that is, the body 1010.

The human-interface HUMAN_IF function refers to a function in which the OS controller 700 outputs a user interface, such as various information or a menu necessary for controlling the cooking appliance, and receives a user's touch input thereto.

One embodiment of controller control and monitoring e function COOK_CONT_MON is that the OS controller 700 provides a signal to the function controller 550 so that the function controller 550 controls the operation of the functional unit 500, that is, the body 110. In addition, one embodiment of the function controller control and monitoring COOK_CONT_MON is that predetermined information collected by the function controller 550, for example, information necessary for monitoring the state or an operation status of the functional unit 500, that is, the body 110, is transmitted to the OS controller 700 in a form of a predetermined wired or wireless signal.

More specifically, when the user selects a specific cooking function in the human-interface HUMAN_IF function, the OS controller 700 may instruct the function controller 550 to execute the cooking function. In addition, the OS controller 700 may perform monitoring to receive values of the operation states or cooking results of the components constituting the functional unit 500 from the function controller 550. All of these functions are included in the function controller control and monitoring COOK_CONT_MON. Accordingly, the function controller control and monitoring COOK_CONT_MON of the OS controller 700 is related to five functions of the function controller 550.

The O_element monitoring O_ELE_MONITORING refers to a function in which the OS controller 700 monitors the components of the digital controller door 600. The OS controller 700 may monitor whether each of the components operates properly, or whether each component operates according to a previous instruction to perform a function.

As shown in FIG. 33, the function controller 550 and the OS controller 700 perform respective given functions independently but in association with each other. Accordingly, the function controller 550 checks whether the OS controller 700 operates normally or not in the process of performing the function, while the OS controller 700 checks whether the function controller 550 operates normally or not in the process of performing the function. When an abnormality occurs in an component of one of the function controller 550 and the OS controller 700, the other of the function controller 550 and the OS controller 700 may cope with this situation.

Hereinafter, a schematic outer appearance and configuration of a cooking appliance including the digital controller door 600 of the present disclosure will be described. This corresponds to one embodiment of the present disclosure, and a scheme and a direction in which the digital controller door 600 is opened may be implemented in various ways.

The present disclosure relates to a scheme for controlling a cooking appliance using a digital controller door disposed at a front surface of the cooking appliance.

According to the present disclosure, a door of a microwave oven disposed on top of an oven or a gas stove acts as a LCD screen (an embodiment of a display). The Android (an embodiment of a OS controller) of the LCD screen and the microcomputer (an embodiment of a function controller) of the microwave oven cooperate with each other. A LCD component operates according to various operating/external environments of the microwave oven or controls a specific function of the microwave oven.

The digital controller door of the present disclosure may be combined with the cooking appliance to open and close the inside of the cooking appliance. An embodiment of the cooking appliance of the present disclosure is a microwave oven. However, embodiments of the present disclosure is not limited thereto. An embodiment of the cooking appliance including the digital controller door of the present disclosure includes each of various cooking appliances which includes a door equipped with a display such as a LCD providing various user interfaces such as a touch screen, and is capable of storing and cooking food therein.

A display may be mounted on a front surface of a digital controller door provided in the cooking appliance of the present disclosure to provide various information to a user. The user may know the cooking state of the cooked food on the display.

In addition, when the display is connected to another home appliance to serve as a hub of the home appliances, the information other than cooking food may be obtained through the display. In addition, a command necessary for cooking and various other commands may be input to the display in a touch manner.

FIG. 34 is a perspective view illustrating a cooking appliance according to an embodiment of the present disclosure. FIG. 35 is a diagram illustrating a state in which the digital controller door 600 is opened in FIG. 34.

According to one embodiment of the present disclosure, the sensor 640 of FIG. 32 includes an illuminance sensor 1410 and an infrared sensor 1420. The illuminance sensor 1410 placed next to a first camera 610a detects the light of the space where the cooking appliance 1000 is placed, for example, the light of the kitchen. The infrared sensor 1420 placed next to the illuminance sensor 1410 detects a person near the cooking appliance 1000.

The sensor 640 according to another embodiment of the present disclosure may be positioned in another area of the digital controller door 600.

The cooking appliance according to an embodiment may be disposed at a position spaced apart from the heating cooking device in the vertical direction above a position where a heating-type oven, a gas stove, etc. are disposed.

Due to the arrangement of the cooking appliance, a user may conveniently use the heating cooking device including the cooking appliance. In addition, the cooking appliance may serve as a hood of the heating cooking device disposed under the cooking appliance. In this case, the cooking appliance may include components for use as the hood.

The cooking appliance may cook food using microwaves belonging to electromagnetic waves and/or heater heat. The cooking appliance may include the body 1010 in which a cavity 1011 is formed, and the digital controller door 600 configured to open and close the cavity 1011. The body 1010 is an embodiment of the functional unit 500 of FIG. 32 as described above. According to an embodiment of the present disclosure, the body 1010 may act in the same manner as the functional unit 500 may. Alternatively, according to an embodiment of the present disclosure, the components of the functional unit 500 may be implemented in the body 1010. Accordingly, in various embodiments, the functional unit 500 and the body 1010 may be interchangeable with each other.

Food to be cooked may be placed in the cavity 1011. The digital controller door 600 may be disposed in front of the cavity 1011 and pivotally mounted at the body 1010 to open and close the cavity 1011.

A ventilation hole 1013 for discharging air suctioned from a suction unit provided at a lower portion of the body 1010 to the outside may be provided at an upper portion of the body 1010. A suction unit may be provided at a lower portion of the body 1010 of the cooking appliance. Accordingly, the cooking appliance may serve as a hood that sucks air discharged from the heating cooking device disposed below the cooking appliance and discharges the air to the outside.

The body 1010 may further include a front panel 1012 provided along an edge of an inlet of the cavity 1011. One surface of the front panel 1012 faces one surface of a choke member 171 when the digital controller door 600 is closed, thereby closing the cavity 1011.

The front panel 1012 may be constructed to surround the edge of the inlet of the cavity 1011 and protrude in a frontward direction and has a predetermined width. Accordingly, when the digital controller door 600 is closed, the edge portion of the digital controller door 600 and the cavity 111 may overlap each other.

Due to this structure, the front panel 1012 may seal the cavity 1011 in a state in which the digital controller door 600 has been closed, thereby preventing oil, moisture, oil vapor, etc. generated during the cooking process of the food placed in the cavity 1011 from being leaked out to the outside through the inlet of the cavity 1011.

FIG. 36 is a perspective view illustrating a digital controller door of a cooking appliance according to an embodiment of the present disclosure.

The digital controller door 600 may include controller hardware (e.g., a hardware chip) or controller software (software including programs) that executes a predetermined algorithm and performs following tasks based on sensing results from various sensors disposed at the cooking appliance or the door and an operating state of the cooking appliance.

In FIGS. 34 to 36, a reference numeral 621 denotes a through hole through which air is introduced or discharged. A first camera 610a and the sensor 640 may be disposed on the front surface of the digital controller door 600. The sensor 640 includes a human sensor, an illuminance sensor, etc.

The display 660 is used to control the cooking appliance 1000 or displays an operation process in the cooking appliance 1000. The ventilation hole 1013 may include a suction portion defined at a lower end of the body 1010 and a discharge portion defined at an upper end of the body 1010. A handle 622 is disposed on one side of the digital controller door 600 such that the user may open and close the digital controller door 600 using the handle.

A second camera 610b may be disposed on an inner side surface of the digital controller door 600, and the second camera 610b may photograph the inside of the cavity 1011 to check the cooking state.

FIG. 37 is a schematic view illustrating a position where a cooking appliance is disposed according to an embodiment of the present disclosure. In FIG. 37, the flow of air is indicated by a solid line arrow, and the transfer direction of heat is indicated by a hidden line arrow. A heating cooking device 2000 may include, for example, an oven and a cooktop disposed on top of the oven.

The cooking appliance may include a convection-based heating device 1031 and a microwave generating device 1032 to heat food accommodated in the cavity 1011.

The convection-based heating device 1031 may generate heat to heat food, and the microwave generating device 1032 may generate microwaves to heat food. The user may select and operate one of the convection-based heating device 1031 or the microwave generating device 1032 to heat and cook food.

The convection-based heating device 1031 may include a convection heater 1031a and a convection fan 1031b. The convection heater may generate heat to heat food accommodated in the cavity 1011. The convection fan 1031b may force the air in the cavity 1011 heated by the convection heater 1031a to flow in the cavity 1011.

When the convection fan 1031b operates, the heated air may be smoothly convectively circulated in the cavity 1011, and accordingly, heat is uniformly supplied to the entire cavity 1011, so that an entirety of the food accommodated in the cavity 1011 may be evenly cooked.

In order to prevent the display 660 provided in the digital controller door 600 from being overheated by the heated air coming up from the heating cooking device disposed under the cooking appliance, resulting in malfunction of or damage to the display 660, it is necessary to cool the display 660 and prevent external heat from being transferred to the display 660. The door fan 680 and the ventilation fan 690 may perform the above role.

The door fan 680 may be disposed inside the digital controller door 600. The door fan 680 may effectively cool the display 660 by flowing air toward the rear surface of the display 660.

In addition, the air flow discharged from the door fan 680 to the outside of the digital controller door 600 may form an air curtain to block the heat rising from the heating cooking device disposed under the cooking appliance.

The ventilation fan 590 may be disposed at a top of the body 1010 and may be disposed in a flow path of the ventilation hole 1013. The ventilation fan 590 may allow air coming up from the heating cooking device to flow to the ventilation hole 1013 to discharge the air to out of the cooking appliance.

Accordingly, when the ventilation fan 590 operates, a significant portion of the heated air coming up from the heating cooking device flows to the ventilation hole 1013 formed in the body 1010, and the flow rate of air heading to the display 660 of the digital controller door 600 may be relatively reduced. As a result, the flow rate of the heated air directed to the display 660 of the digital controller door 600 is reduced, thereby suppressing overheating of the display 660.

In order to block overheating of the display 660, it is necessary to appropriately use the door fan 680 and the ventilation fan 590. Since one of main purposes of the door fan 680 is to prevent the overheating of the display 660, the door fan 680 may operate in a low-speed rotation mode and a high-speed rotation mode based on the temperature condition of air approaching the digital controller door 600.

The door fan 680 has a small amount of air blown in the low-speed rotation mode and a large amount of air blown in the high-speed rotation mode. Therefore, the temperature of the display 660 may be effectively lowered by the door fan operating in the low-speed rotation mode when the temperature of the air is low and by the door fan operating in the high-speed rotation mode when the temperature of the air is high.

In order to reliably suppress the overheating of the display 660, it is advantageous to operate both the door fan 680 and the ventilation fan 590 and operate the door fan 680 in the high-speed rotation mode.

The thermistor 595 disposed at a bottom of the cooking appliance 1000 may sense the heat from the heating cooking device disposed under the cooking appliance 1000. In addition, the auto ventilation function may operate upon sensing the heat.

In the embodiment of FIG. 37, the outside lamp 580 may emit light toward the lower end. For example, when the user touches the digital controller door 600, the outside lamp 580 may be turned on. Alternatively, when a movement of a person is identified and ambient illuminance is lower than or equal to a predetermined reference (for example, illuminance 10 lux or lower), the outside lamp 580 may be turned on under the control of the OS controller 700.

In addition, the door lamp 695 may be disposed at a lower end of the digital controller door 600. For example, when the user touches the digital controller door 600, the door lamp 695 may be turned on. Alternatively, when a movement of a person is identified and ambient illuminance is lower than or equal to a predetermined reference (for example, illuminance 10 lux or lower), the door lamp 695 may be turned on under the control of the OS controller 700.

According to an embodiment of the present disclosure, the outside lamp 580 may be controlled by the function controller 550. In this case, the OS controller 700 may instruct the function controller 550 to turn on/off the outside lamp 580.

According to another embodiment of the present disclosure, the outside lamp 580 may be directly controlled by the OS controller 700. In this case, the outside lamp 580 may be disposed in the functional unit 500, but may be controlled by the OS controller 700 of the digital controller door 600.

FIG. 38 is a view showing a detailed configuration of a sensor according to an embodiment of the present disclosure. The sensor 640 may include the illuminance sensor 1410 and the infrared sensor 1420. The illuminance sensor 1410 detects light in a space in which the cooking appliance 1000 is disposed, for example, illuminance of a kitchen. The infrared sensor 1420 detects a person near the cooking appliance 1000.

The OS controller 700 determines that there is a person near the cooking appliance 1000 using the information sensed by the illuminance sensor 1410 and the infrared sensor 1420. For example, when the ambient illuminance sensed by the illuminance sensor 1410 is lower than the reference illuminance (a predetermined illuminance reference) and the infrared sensor 1420 senses the human body (when a person is detected nearby), the OS controller 700 performs a mood-light effect process.

In an embodiment of performing the mood-light effect process, the OS controller 700 may provide the mood-light effect by controlling the outside lamp 580 at the lower end of the cooking appliance 1000 or a separate door lamp 695 or the display 660 disposed on the digital controller door 600.

In summary, the OS controller 700 controlling the digital controller door 600 checks the ambient illuminance sensed by the illuminance sensor 1410 disposed in the digital controller door 600 and the human body sensing information sensed by the infrared sensor 1420 disposed in the digital controller door. In addition, the OS controller 700 may perform the mood-light effect process based on the checked information.

One embodiment of the mood-light effect process includes a process in which the OS controller 700 turns on the outside lamp 580 disposed in the functional unit 500 or the door lamp 695 disposed in the digital controller door 600.

Another embodiment of the mood-light effect process includes a process in which the OS controller 700 outputs an image or video on the display 660 disposed on the front of the digital controller door 600.

In order to perform the above-described process, the OS controller 700 may perform the function controller control and monitoring COOK_CONT_MON. To this end, the OS controller 700 may periodically receive information from the function controller 550. In this regard, in an embodiment of the function controller control, the OS controller 700 transmits a predetermined signal to the function controller 550 so that the function controller 550 may control the function unit 500, that is, the main body 1010.

FIG. 39 is a view illustrating a process of sensing a movement of a person and providing a mood-light effect based on the sensing result, according to an embodiment of the present disclosure.

The OS controller 700 checks the ambient illuminance sensed by the illuminance sensor 1410 in S10. The OS controller 700 checks whether the ambient illuminance is lower than the predetermined reference illuminance OUT_LUX in S11. In response to that the ambient illuminance is equal to or greater than the reference illuminance (e.g., 10 lux), the process proceeds to the step S10.

The reference illuminance about the ambient illuminance may vary according to the operation state of the cooking appliance 1000 or the control of the user's mood. The reference illuminance may be preset, may be changed according to a user's manipulation, or may be automatically changed and stored according to a user's behavior pattern.

For example, when the user stops the mood-light effect after the mood-light effect is activated, the OS controller 700 may reset the reference illuminance using the information on the sensed ambient illuminance before performing the mood-light effect process. In addition, the OS controller 700 may display a guide message about the changing of the reference illuminance through the display 660 and then provide a user interface through which the user may return the reference illuminance to its default value or set the reference illuminance to a different value.

Otherwise, in response to that the ambient illuminance is lower than the predetermined reference illuminance OUT_LUX, the step S12 is performed.

The OS controller 700 checks whether the infrared sensor 1420 detects the human body in S12. In response to that the human body is detected (S12—Yes), the OS controller 700 performs the mood-light effect process in S19.

FIG. 40 is a diagram illustrating a process of providing a mood-light effect based on a time zone according to an embodiment of the present disclosure.

S10 to S12 and S19 may refer to FIG. 39. In response to that the human body is detected (S12—Yes), the OS controller 700 determines whether to activate the mood-light effect based on “a difference between the ambient illuminance and the reference illuminance OUT_LUX” and “time zone information to which a current time belongs” in S13.

For example, when the difference between the ambient illuminance and the reference illuminance OUT_LUX is small (e.g., 0.5, 1, etc.) and when the current time is a daytime zone, the OS controller 700 may not perform the mood-light effect process. A reference value related to the difference between the ambient illuminance and the reference illuminance OUT_LUX may be preset, such as 1 or 0.5. Alternatively, the reference value related to the difference may be reset according to a use environment of the cooking appliance 1000.

Accordingly, in response to that it is determined that the mood-light effect should be activated (Yes in the step S13), the OS controller 700 proceeds to the step S19.

The process of FIG. 40 is a process in which the OS controller 700 determines whether to perform the mood-light effect process, based on the difference between the ambient illuminance and the reference illuminance and the current time information. The daytime zone to which the current time information belongs may vary depending on the season. In another example, the difference between the ambient illuminance and the reference illuminance may also vary depending on the season.

FIG. 41 is a view illustrating a process of providing a mood-light effect based on a length of a timed duration for which an infrared sensor detects a person according to an embodiment of the present disclosure.

S10 to S12 and S19 may refer to FIG. 39. In response to that the human body is detected (S12—Yes), the OS controller 700 checks whether the time duration for which the infrared sensor 1420 has detected the human body is equal to or greater than a reference detection time duration MAX_HUMAN_SENSE in S15. A case in which the human body has been detected only for a very short time duration (for example, 0.5 seconds, 1 second, etc.) corresponds to a case in which the user passes by rather than doing any work around the cooking appliance 1000. In this case, a determination result in S15 is No, such that the OS controller 700 may not perform the mood-light effect process.

Accordingly, the OS controller 700 performs the mood-light effect process in S19 only when the time duration for which the infrared sensor 1420 has detected the human body is equal to or greater than the reference detection time duration MAX_HUMAN_SENSE (S15—Yes).

FIG. 42 is a diagram illustrating a process in the event that an input for stopping the mood-light effect process occurs after performing the mood-light effect process according to an embodiment of the present disclosure.

S10 to S12 and S19 may refer to FIG. 39. The cooking appliance 1000 may turn on the outside lamp 580 or the door lamp 695 according to the mood-light effect process. Alternatively, the display 660 of the digital controller door 600 may output a predetermined image or video according to the mood-light effect process.

However, the user may press a specific button disposed on the cooking appliance 1000 or generate an input for stopping the mood-light effect process using an interface displayed on the display 660. That is, whether the input for stopping the mood-light effect process occurs is determined in S21. This means that the user does not want the mood-light effect in the current situation. Accordingly, the OS controller 700 stores a counter in response to the stop of the mood-light effect as a history in S22. In this case, the OS controller 700 may store, as a history, the ambient illuminance information of the S11 and the S12 or the time duration information for which the human body has been detected before performing the mood-light effect process-light effect.

The counter value may continue to increases. When the cooking appliance 1000 is first opened, the counter value may start at 0. When the counter value reaches a stop limit (for example, 5 times or 10 times), the OS controller 700 deactivates the mood-light effect process in S23.

At this time, the OS controller 700 displays a message indicating that the mood-light effect process is deactivated on the display 660 so that the user may activate the mood-light effect process again. When the mood-light effect process is activated again by the user manipulating the interface displayed on the display 660, the above-described counter value may also be reset.

In addition, the OS controller 700 may store the ambient illuminance or the human body detection time duration when the input of stopping the mood-light effect occurs, and then, apply the stored illuminance or human body detection time duration to set the reference illuminance of FIG. 39 or the reference detection time duration of FIG. 41.

For example, it is assumed that the reference illuminance OUT_LUX is 10. The OS controller 700 stores a history in which the user stops the mood-light effect process after performing the mood-light effect process when the ambient illuminance is 8 or 9. In addition, the OS controller 700 stores a history in which there is no separate stop input after performing the mood-light effect process when the ambient illuminance 7 or 6.

In this case, the OS controller 700 may set a value of the reference illuminance OUT_LUX to which the ambient illuminance is to be compared to 8.

Similarly, it is assumed that the reference detection time duration MAX_HUMAN_SENSE is 0.5 seconds. The OS controller 700 stores a history in which the user stops the mood-light effect process after performing the mood-light effect process when the time duration for which the human body has been detected is 0.5 seconds. In addition, the OS controller 700 stores a history in which there is no separate stop input after performing the mood-light effect process when the time duration for which the human body has been detected is 1 second.

In this case, the OS controller 700 may set the reference detection time duration MAX_HUMAN_SENSE as a temporal reference for sensing the human body, to 1 second.

FIG. 43 is a diagram illustrating a process of terminating a mood-light effect process after performing the mood-light effect process according to an embodiment of the present disclosure.

The OS controller 700 starts the mood-light effect process as described in S19. To this end, the OS controller 700 may control the outside lamp 580, the door lamp 695, or the display 660 in S31.

The OS controller 700 monitors the values sensed by the illuminance sensor 1410 and the infrared sensor 1420.

In an embodiment, the OS controller 700 checks whether the ambient illuminance is lower than the predetermined reference illuminance OUT_LUX in S32.

In response to that the ambient illuminance is not lower than the reference illuminance (for example, 10 lux) (that is, in response to that the ambient illuminance is equal to or greater than the reference illuminance), the OS controller 700 terminates the mood-light effect process in S34 because the outside is in a sufficiently bright state. The reference illuminance to which the ambient illuminance is to be compared may vary according to an operation state of the cooking appliance 1000 or in response to control of a mood-light effect process by the user.

Otherwise, in response to that the ambient illuminance is lower than the predetermined reference illuminance OUT_LUX, step S33 is performed.

The OS controller 700 checks whether the infrared sensor 1420 detects the human body in S33. In response to that the human body is detected (S33—Yes), the OS controller 700 maintains the mood-light effect process and proceeds to step S32.

Otherwise, when the infrared sensor 1420 does not detect the human body (S33—No), this indicates that the user has left a position around the cooking appliance 1000. Thus, the OS controller 700 terminates the mood-light effect process in S34.

In the embodiment of FIG. 43, a timer may be applied. That is, a time duration (1 minute or 2 minutes, etc.) for which the mood-light effect process is maintained is set. In this case, the OS controller 700 may terminate the mood-light effect process in response to that the above-described set time duration has elapsed regardless of the ambient illuminance or the human body detection situation, and may turn off the outside lamp 580 or the door lamp 695 that has been turned on in the process of performing the mood-light effect process. Alternatively, when the mood-light effect process has been terminated, the output of the image or video on the display 660 of the digital controller door 600 may also be terminated.

In S32, the OS controller 700 may consider a situation in which the ambient illuminance is changed due to the mood-light effect being activated. For example, it is assumed that the ambient illuminance becomes 10 after the mood-light effect process has been performed in a state in which the ambient illuminance is 8. The OS controller 700 determines the change in the illuminance due to the activation of the mood-light effect as 2. Accordingly, in the process S32, the OS controller 700 may subtract 2 from the sensed ambient illuminance and then compare the subtraction result with the reference illuminance OUT_LUX.

According to an embodiment of the present disclosure, the OS controller 700 may perform the mood-light effect process in the auto ventilation situation.

When the thermistor 595 detects the temperature, the ventilation fan 590 may automatically operate based on the detected temperature. This is referred to as an auto ventilation. The function controller 550 may automatically execute the auto ventilation function based on the temperature sensed by the thermistor 595 to prevent component failure or damage. That is, when the function controller 550 detects that the temperature of the thermistor is equal to or higher than a predetermined temperature, the function controller may execute the auto-ventilation function, and accordingly, may notify the OS controller 700 of information indicating that the auto-ventilation is activated.

In response to reception of the notification, the OS controller 700 may display an auto ventilation operation state on the display 660.

The OS controller 700 may display, on the display 660, a pop-up message indicating that the auto ventilation is being activated when the temperature sensed by the thermistor 595 reaches a predetermined temperature condition. This is a function that the user may not cancel or change arbitrarily. Accordingly, the OS controller 700 may display information indicating that the auto ventilation operation is being performed on the display 660 and may also output a message indicating that the auto ventilation operation cannot be changed or cancelled. The user may not set a timer for this auto ventilation operation. The ventilation fan 590 is terminated when the auto ventilation has been terminated even though the user turns off the cooking appliance 1000 on the display 660.

In addition, the auto-ventilation may be executed when a timer is set. In this case, the OS controller 700 may display a remaining timer time on the display 660 when the auto-ventilation operation has been terminated. In addition, when the auto-ventilation operation ends and the timer time ends, the ventilation fan 590 is also turned off.

In one example, when the user starts to operate the ventilation fan 590 during the cooking, an operation intensity of the ventilation fan 590 may not be set to a turbo level (strong intensity). After the cooking has been finished, the ventilation fan 590 may operate in the turbo level as long as the previously set ventilation fan intensity is the turbo level.

As described above, the auto ventilation function refers to a function provided to protect components of the cooking appliance 1000. Accordingly, when an error occurs in a process in which the function controller 550 cooperates with the OS controller 700, the operations of other components of the functional unit 500 may be canceled, but the operation of the ventilation fan 590 executing the auto ventilation may be maintained. Similarly, even when there is no instruction from the OS controller 700, the function controller 550 may automatically start or end the operation of the ventilation fan 590 based on the temperature sensed by the thermistor 595.

Accordingly, when the auto ventilation function operates, the OS controller 700 may perform the mood-light effect process.

According to the embodiment of the present disclosure, the cooking appliance 1000 including the digital controller door 600 may provide the mood-light effect using the outside lamp 580, the door lamp 695, or the display screen in connection with the sensor (e.g., the infrared sensor) for sensing the human body and the illuminance sensor as disposed in the product. The mood-light effect may be controlled by the digital controller door 600. The cooking appliance according to an embodiment of the present disclosure may implement the mood-light effect based on the magnitude of ambient illuminance, the result of sensing the human body, etc.

When a movement of a person is detected (the infrared sensor detects a motion of the human body) in a state in which the ambient illuminance as detected by the illuminance sensor 1410 of the digital controller door 600 is lower than or equal to the predetermined reference (e.g., lower than or equal to 10 Lux of illuminance), the OS controller 700 may control the outside lamp 580 disposed on the outer surface including the lower end surface or the upper end surface of the cooking appliance 1000 to be turned on to perform the planar illumination. In this regard, the planar illumination provides the mood-light effect.

Alternatively, in response to that the sensor of the digital controller door 600 detects the magnitude of the ambient illuminance and the movement of a person, the OS controller 700 may control the display 660 such that the display 660 (e.g., LCD) constituting the door outputs a specific color, shape, or pattern.

In addition, the OS controller 700 of the digital controller door 600 activates the mood-light effect (planar illumination) or turns on the LCD screen, and then outputs a user experience (UX) through which the user can deactivate the mood-light effect or turn off the LCD screen or change a setting, so that the user can change a state or condition in which the mood-light effect or the LCD screen is turned off or turned on. In addition, the OS controller 700 of the digital controller door 600 of the cooking appliance may store such a change state and then turn on/off the mood-light effect or the LCD in the same situation based on the storing result.

In response to that the infrared sensor 1420 detects that the person is out of the space in which the home appliance is positioned in the process of detecting the movement of the person, the OS controller 700 of the digital controller door 600 according to an embodiment of the present disclosure may terminate the mood-light effect process to deactivate the mood-light effect (planar illumination) again.

In addition, in activating or deactivating the mood-light effect, the OS controller 700 of the digital controller door 600 may output a predetermined notification sound indicating an on/off state of the mood-light effect using a speaker or may display an on/off state of the mood-light effect on the display 660.

An embodiment of the present disclosure in which all the components are combined with each other or operate in combination with each other has been described. However, the present disclosure is not necessarily limited to this embodiment. Within the scope of the purpose of the present disclosure, at least two of all components may be selectively combined with other or may operate in the selectively combined manner with other. Furthermore, each of the components may be implemented as an independent hardware. However, some or all of the components may be selectively combined with each other and thus may be implemented using a computer program with a program module to perform some or all of the functions combined in one or more pieces of hardware. The codes and code segments that constitute the computer program may be easily deduced by a person skilled in the art from the present disclosure. The computer program may be stored in computer readable media and read and executed by a computer, thereby implementing the method of the present disclosure. The storage media for storing the computer program may include storage media including magnetic recording media, optical recording media, and semiconductor recording devices. Additionally, the computer program implementing an embodiment of the present disclosure includes a program module transmitted in real time through an external device.

Although the embodiments of the present disclosure have been described in more detail with reference to the accompanying drawings, the present disclosure is not necessarily limited to these embodiments, and may be modified in a various manner within the scope of the technical spirit of the present disclosure. Accordingly, the embodiments as disclosed in the present disclosure are intended to describe rather than limit the technical idea of the present disclosure, and the scope of the technical idea of the present disclosure is not limited by these embodiments. Therefore, it should be understood that the embodiments described above are not restrictive but illustrative in all respects. In addition, even though an effect of a configuration of the present disclosure is not explicitly described in describing the embodiment of the present disclosure above, it is obvious that the predictable effect from the configuration should be recognized.

What is claimed is:

1. A cooking appliance comprising a main body with a cavity defined therein, and a door configured to open and close the cavity, wherein the main body includes:
a bottom panel disposed at a bottom; and
a lighting member installed in the bottom panel and configured to irradiate light in a downward direction of the cooking appliance,
wherein the lighting member includes:
a light source board where a plurality of light sources are aligned to be spaced apart from each other; and
a diffusion plate disposed under the light source board and configured to diffuse light irradiated from the light sources.

2. The cooking appliance of claim 1, wherein the bottom panel includes a lighting mounting hole defined such that a longitudinal direction thereof is parallel to a lateral direction of the bottom panel, wherein the lighting member is mounted in the lighting mounting hole.

3. The cooking appliance of claim 1, wherein the bottom panel includes a suction member formed to extend through the bottom panel and configured to suck foreign substances rising from a space below the cooking appliance, and
wherein the lighting member is disposed in front of the suction member.

4. The cooking appliance of claim 2, wherein the lighting member includes:
a cover glass disposed under the diffusion plate and constructed to close an interior of the lighting member; and
a lower cover disposed under the cover glass and coupled to the bottom panel, wherein the cover glass is mounted on the lower cover.

5. The cooking appliance of claim 4, wherein the lighting member includes a reflector disposed on the light source board and constructed to accommodate the light source board therein, wherein the reflector is configured to reflect light irradiated from the light source so as to be directed downward.

6. The cooking appliance of claim 5, wherein the reflector includes:
a first part protruding to define a space for accommodating the light source board; and
a second part extending from both ends of the first part and coupled to a top surface of the bottom panel.

7. The cooking appliance of claim 6, wherein the lower cover includes:
a first catching protrusion protruding upward from an edge of the lower cover and inserted through the bottom panel and the second part; and
a first bendable protrusion protruding upward from the edge of the lower cover and bent to be coupled with the diffusion plate.

8. The cooking appliance of claim 7, wherein the bottom panel includes:
a first bent portion formed by bending at an edge of the lighting mounting hole; and
a first insertion hole defined in the first bent portion, wherein the first catching protrusion is inserted into the first insertion hole,
wherein an end of the first catching protrusion includes a bent first catching bent portion, and
wherein the first catching bent portion is caught on the first bent portion.

9. The cooking appliance of claim 7, wherein the diffusion plate includes a first bendable protrusion coupling portion protruding from an edge thereof, and
wherein the first bendable protrusion is bent and coupled to the first bendable protrusion coupling portion.

10. The cooking appliance of claim 7, wherein the second part includes a first sub-insertion hole defined at a location corresponding to the first catching protrusion, and
wherein the first catching protrusion is inserted into the first sub-insertion hole.

11. The cooking appliance of claim 7, wherein the bottom panel includes:
a second catching protrusion protruding upward from an edge of the lighting mounting hole and inserted through the second part; and
a second bendable protrusion protruding upward from the edge of the lighting mounting hole and bent to be coupled with the second part.

12. The cooking appliance of claim 11, wherein the second part includes a second insertion hole defined at a location corresponding to the second catching protrusion,
wherein the second catching protrusion is inserted into the second insertion hole,
wherein an end of the second catching protrusion includes a bent second catching bent portion, and
wherein the second catching bent portion is caught on the second part after passing through the second insertion hole.

13. The cooking appliance of claim 11, wherein the second part includes a protrusion placement recess defined to be recessed from an end thereof and defined at a location corresponding to the second bendable protrusion, and
wherein the second bendable protrusion is bent after passing through the protrusion placement recess to be coupled to the second part.

14. The cooking appliance of claim 4, wherein the lower cover includes an exposure hole constructed to expose the cover glass to the outside, and
wherein an area size of the exposure hole is smaller than an area size of the cover glass.
